(19) United States
(12) Patent Application Publication
(10) Pub. No.: US 2026/0309181 A1
(43) Pub. Date: Oct. 8, 2026

(54) FASTENERS, FASTENER ARRANGEMENTS AND TOOLS FOR APPLICATION AND/OR RELEASE OF FASTENERS

(71) Applicant: ENGENTUS PTY LTD, Osborne Park (AU)

(72) Inventors: Brian Eric BRADSHAW, Halls Head (AU); Tom Peter BASKOVICH, Trigg (AU); Sam William TURNBULL, Joondanna (AU)

(21) Appl. No.: 19/710,971

(22) Filed: Jun. 17, 2026

Related U.S. Application Data
(63) Continuation of application No. 18/175,405, filed on Feb. 27, 2023, now abandoned.
Application No. 18/175,405 is a continuation of application No. PCT/AU2021/050995, filed on Aug. 27, 2021.

(30) Foreign Application Priority Data
Aug. 27, 2020 (AU) 2020903063
Dec. 17, 2020 (AU) 2020904716

(51) Int. Cl. F16B 35/04; B25B 23/00

(52) U.S. Cl. CPC F16B 35/042; B25B 23/0085

(57) ABSTRACT

A threaded male member 12 for a fastening arrangement has a reaction portion 16, such as a splined end or engagement portions in a threaded end. The threaded male member can have an internal or external secondary reaction portion 16.1 and a fail region 17. A tool 36 can have concentric sockets having a first socket 38 to engage the reaction portion 16 and a second socket 40 to engage the nut 18. An anti-rotation device 28 can be applied to the reaction portion and a nut 18 after fastening. A retainer 119 can engage with the reaction portion or the fail region 17. The retainer can bias the nut in a tightening direction. Rate of change in applied torque (ΔT) relative to a change in rate of change of angle (ΔA) of rotation can be sensed and used to determine correct tightening.

### CROSS REFERENCE TO RELATED APPLICATIONS

This application is a continuation of co-pending U.S. application Ser. No. 18/175,405 filed on Feb. 27, 2023, which is a continuation of International Application No. PCT/AU2021/050995, filed Aug. 27, 2021, which claims priority to Australian Application No. 2020904716, filed Dec. 17, 2020, and Australian Application No. 2020903063, filed Aug. 27, 2020, all of which are incorporated by reference herein.

### FIELD OF THE INVENTION

The present invention relates to fasteners, fastener arrangements and systems, components thereof and therefor, such as nuts, bolts, threaded rods, threaded male members, and/or to tools and systems comprising fasteners and tools for applying and/or releasing fasteners.

One or more non-limiting forms of the present invention includes fasteners and/or fastening arrangements that incorporate a threaded male member, such as a threaded bolt, threaded male member and/or threaded rod, generally known as externally threaded fasteners.

One or more non-limiting forms of the present invention provides a tool arrangement (e.g. system, device, tool, combination of tools) for use in applying and/or releasing nut type fasteners, such as segmented nut type fasteners, generally known as internally threaded fasteners.

One or more non-limiting forms of the present invention is applicable to fastening arrangements for use in fastening flange joints, such as pipe flanges used in oil & gas and other industrial pipeline systems, vehicle applications (e.g. wheel rim fastening systems for mining vehicles), commercial and industrial cryogenic pipeline systems, and other gas and liquid conveying pipelines.

One or more non-limiting forms of the present invention is particularly applicable to improving upon, replacing or augmenting standard nut and threaded bar/rod fastening systems.

For the purposes of elucidating the present invention, the term “threaded male member” encompasses a bolt (such as having a head), a threaded rod (such as not having a head or having one end fixed) or threaded male member (which may or may not have a head, and may or may not be fixed), each having an external thread at least along a portion of a shaft of the male member. A ‘threaded male member’ and ‘threaded rod’ are considered to be the same and interchangeable. These are sometimes referred to as ‘stud-bolts’ in various industries.

### BACKGROUND TO THE INVENTION

The practice of using two nuts, one on either end, on a threaded male member or rod with (such as for fastening a flange joint) is widespread and well established within industries, such as construction, oil & gas and mining applications.

Tightening of a threaded nut and bolt arrangement occurs when the nut and bolt are rotated relative to one another in the correct tightening direction for that arrangement (usually right-handed ‘clockwise’ rotation for tightening of a nut). When considering a nut and bolt fastened joint from the nut side, it is quite inconsequential as to whether the bolt remains fixed and the nut rotates in the ‘clockwise’ tightening direction, or the nut remains fixed and the bolt rotates in the contra ‘anti-clockwise’ direction. Tension is developed in the bolt in either case.

A threaded male member is threaded at or towards both ends (the thread may extend along the complete length of the stud or may have one or more plain, unthreaded (“shank”) sections intermediate the ends). That is, the threaded male member or rod typically has a helical thread (of the same handedness) extending along all of, or at least a significant length of, the stud/rod. Threaded rod in bar stock form is often called ‘all-thread’. The threaded male member differs from a bolt in not having a typical wide, tool engageable, head preventing the shaft of bolt pulling through the joint in one direction.

Such studs are designed to be used in tension. A threaded male member connection has a fastening nut on either side of the joint, such as a joint where two opposed flanges are held together by a number of nut and stud fastening arrangements. The nut having torque applied to it can be referred to as the ‘front’ nut whilst the nut on the other/reverse side of the joint can be referred to as the ‘back’ nut. The tension developed in the threaded male member is thus dependent on the relative rotation of the two nut thread interfaces.

Using power tools to install and remove nuts avoids the need for laborious use of manually operated tools, such as spanners, wrenches and sockets. Using power tools is often a first choice in removing nuts but in some cases may not avoid the need to cut the nut from the bolt using oxy-acetylene cutting equipment (commonly referred to as ‘gas-axing’ or ‘gas-cutting’) in those cases where the nut is difficult to remove due to seizure, thread-damage or the like. Use of such gas cutting equipment creates a severe fire risk and a burn risk to an operator, and also typically requires an additional person as a fire watch warden, thereby tying up personnel resources that could be deployed elsewhere. There are also well documented productivity losses associated with such gas-axing/gas-cutting procedures as the equipment remains too hot to work on for a period after the procedure and there are various ‘hot-works’ safety requirements implemented which take up significant time.

Use of conventional power tools will generate a reaction torque in an opposite direction to the torque applied by the power tool. In industrial applications, the tightening/release torques used on fastener assemblies is often beyond that capable of being safely reacted by a human operator.

Counter-rotation of the power tool may trap or crush the operator's hand in a ‘pinch-point’ between the power tool and a work-piece/equipment adjacent the nut/power tool, such as in restricted access areas.

Reaction fixtures have been used with such tools whereby an arm (a “reaction arm”) is attached to the power tool in a fixed position and extends to engage against the fixed body of the equipment to which the nut type fastener is attached. Reaction torque of the power tool is transferred through the reaction arm to the body of the equipment and prevents the power tool counter-rotating. However, there is still a risk that the operator may get injured by a hand or finger getting trapped between the reaction arm and the body of the equipment, particularly if there is limited access/vision and/or the power tool/reaction arm needs repositioning.

Tension control bolts and a shear wrench have been used for installing permanent preloaded or High Strength Friction Grip (HSFG) bolts. Tension control bolts have been used to replace conventional high strength friction grip bolts and swaged collar rivets simply because they are quick and easy to install using lightweight electric shear wrenches. Guaranteed torques together with visual inspection as the reaction tip of the bolt is sheared off as a positive confirmation of successful bolting removes the likelihood of operator error and ensures engineers that connections are tightened in accordance with specifications and are used where permanent, long life, jointing is required (as opposed to regularly serviceable joints where dismantling and re-assembly are required).

In one version, the tension control bolt arrangement uses a reverse handed thread for the backing nut (the rear nut) and a plain shaft (unthreaded) shank section separating the threaded end sections. The tension control bolt arrangement was developed to overcome access problem where a bolt could not be inserted or access to torque application tools was limited-the tension control bolt arrangement allowing the stud to be inserted whilst a reverse threaded nut (e.g. left-handed thread on the nut and stud end) is held in place. The backing (rear) nut and associated stud thread being reverse handed prevents the backing nut from unthreading and the stud from pulling through the joint during the final tightening process. The use of opposite handed nuts and specially designed stud thread can be an impediment for adoption in certain industries and applications which have long standing regulations and practices.

US patent document US 2008/0226411 discloses a dual torque setting tension control fastener that uses a nut and a fixed stud having a pair of adjacent breakaway sections at one end. A first shear torque shears off the first breakaway section, and a second, higher, torque shears off the remaining (second) breakaway section. Consequently, after tightening, neither breakaway section remains on the fixed stud. The aim is to ensure a correct torque is applied to the fastening system. No particular reaction/counter-torque arrangement is provided for subsequent removal of the nut.

That is, US 2008/0226411 teaches an arrangement for ensuring a minimum torque is applied to ensure correct fastening, but no account is taken of any need to subsequently release the nut at a later occasion and therefore retaining the second or first and second sections is not required, and in fact, removal of the first and second sections ensures they do not continue to project outward from the fastener after nut tightening.

In accordance with the present invention, retaining the reaction portion at the end of the fixed stud enables a retainer/anti-rotation device or indicator to be applied to the reaction portion and engage with the respective nut. It also allows the nut to be removed by reacting the removal torque against the reaction portion.

By suitable choice of specific design parameters, for example material, dimensions, geometric features, and\or heat-treatment the reaction portion of the present invention can be adapted to fail (i.e. shear or otherwise become visibly damaged) as an indication of failure of the bolting process. This is in contradistinction to, for example, tension control bolts which require the shearing of the reaction portion as a confirmation of successful bolting.

An alternative approach to reduce or remove the risks associated with reaction torque when trying to release nut type fasteners is provided by a washer incorporating a profiled circumference somewhat like a thin sprocket or toothed gear. The washer, which is of a larger diameter then its associated nut, goes between the regular (hexagonal) nut and the work-piece, and is held in that position through the friction forces between the nut and the working face of the equipment to which it is attached and is ultimately reacted back to the ground upon which the equipment is placed. A double layered socket mounted on a driven end of the power tool slides over the nut to be released. The outer layer of the socket engages with the shaped profile of the teeth and valleys on the washer's circumference. The inner layer of the socket engages with the nut. Release torque is applied by the inner layer whilst the reaction torque is reacted through engagement of the outer layer with the washer.

The present invention has been developed in the light of the aforementioned background. One or more forms of the present invention proposes at least one alternative, or one or more useful alternative approaches, to alleviating one or more problems associated with one or more of reaction torque, need to safely release nut type fasteners, need to ensure fastening systems are correctly torqued and/or remain fastened.

### SUMMARY OF THE INVENTION

Embodiments of the present invention provide a method of fastening or releasing a threaded male member fastening arrangement having a threaded male member and at least one nut, the method including applying a torque to the respective nut and applying a counter-torque to a reaction portion at a first end of the threaded male member.

As noted above, ‘threaded male member’ can encompass any externally threaded fastener, such as a bolt, a threaded rod or a threaded male member.

The threaded male member can have a nut threaded thereon at a second end of the threaded male member, and the torque and the counter-torque is applied at the first end of the threaded male member.

The reaction portion can remain as part of the threaded male member after required application of the torque to tighten the respective nut(s) to a required tightening torque.

For release of a tightened said nut, the method may include applying a release torque to the nut and a counter-torque to the reaction portion.

For release of a tightened said nut, the method may include engaging a tool with the reaction portion, with an inner nut of a segmented nut and with an outer collar/sleeve of the segmented nut, applying a torque to the inner nut and the sleeve/collar or to the reaction portion and the sleeve/collar, or with the reaction portion, inner nut and sleeve/collar, for release of the nut.

The method may include applying an anti-rotation device to a tightened said nut and reaction portion. For example, an anti-rotation device so applied can act to prevent, or at least restrict, premature release/loosening of the tightened nut, and may be provided with a rotation indicator to show the nut is tightened or has loosened.

The method may include applying a cap over the nut to engage with the nut and the reaction portion. The method may include applying a resilient device or clip to the reaction portion and the nut.

Embodiments of the present invention may include an anti-rotation device including an axial retention means to retain the anti-rotation device on the reaction portion, nut, or both.

An axial retention means of the anti-rotation device (such as a cap) may be realised through a friction due to interference or residual torque between the anti-rotation device and a plain or axially detailed section of the reaction portion and/or the nut. The axial retention means of the anti-rotation device (such as a cap) may be realised through a mechanism, which may be an additional mechanism, that interacts with axially detailed sections of the anti-rotation device and the nut, reaction portion, the thread portion between the nu and the reaction portion, or any combination thereof.

It will be understood that when installed, the anti-rotation device is prevented from rotating relative to the externally threaded fastener. Therefore, the threaded portion of the externally threaded male member/fastener can provide a suitable means to provide an axial restraint to the anti-rotation device to prevent unintended detachment of the anti-rotation device from the fastening arrangement/assembly during use.

The axial retention means of the anti-rotation device may also serve as a means of tamper proofing, if some special tooling is required to disengage the axial retention means and allow the anti-rotation device to be removed from the reaction portion and the nut, in turn allowing the removal of the nut from the externally threaded fastener.

The anti-rotation cap may also feature a means of conserving the nut, exposed threads beyond the nut, and/or the reaction section. This may include corrosion inhibition through use of passive shielding or active protection through VCI film.

The anti-rotation cap may feature some means of providing a biased torque to the nut in its tightening direction relative to the externally threaded fastener. This biased torque may work to prevent loosening of the nut relative to the threaded fastener when in operation.

An anti-rotation device, such as a locking device to lock a nut and threaded male member together during fastening (e.g. functioning similar to that of a ‘backup wrench’), may need to withstand a minimum torque in the order of 15% of the applied tightening torque. Therefore, choice of material and design for the device would take this possibility into account. Also, any free-play in the anti-rotation (e.g. locking device) may be taken up during tightening of the fastener arrangement.

The anti-rotation device may be arranged and configured to withstand and remain functional for torque ratings up to a maximum applied torque during tightening.

As there may be a residual torque within the anti-rotation device (e.g. locking device), such as between a reaction portion/spline and a nut, after the tightening has been completed, the anti-rotation device may incorporate a residual torque relief means, e.g. a clamp around that part of the anti-rotation device that engages on the reaction portion which allows radial movement away from the reaction portion/spline.

The anti-rotation device may only require to internally react notable smaller torques. It is considered appropriate that the anti-rotation device (for example, when applied after completion of fastening) may withstand a torque as required by ISO 2320 ‘Min 1st removal prevailing torque’, ensuring that embodiments of the present invention exceeds the self-loosening resistance of a prevailing torque type nut.

By way of example, for an M20 Class 8.8 structural assembly, which may be torqued up to approximately 450 Nm, a locking device would need to withstand approximately 67.5 Nm torque, whereas an anti-rotation device requiring lesser torque resistance, may be required to withstand only approximately 10 to 15 Nm. It will be appreciated that the anti-rotation device may be designed to withstand significantly more than 10 to 15 Nm.

It will be appreciated that embodiments of the present invention may include a rotation indication device.

The rotation indication device may include a visual indicator providing an indication that the nut and threaded male member have not or have rotated relative to one another, a positive indication of relative rotation thereby indicating loosening of the fastening arrangement.

Embodiments of the present invention may include the anti-rotation device (such as a locking device) also having rotation indication features for providing a rotation indication function of a nut relative to a threaded male member of a fastening arrangement of the present invention.

It will be appreciated that, to avoid a clash situation between a reaction portion/spline interface and the hex-nut interface to the anti-rotation device or rotation indicator device, structural geometry of the anti-rotation device/rotation indicator device may incorporate a degree of free play. For example, for a standard hex-nut (female fastener) and a 12-point spline (reaction portion on a threaded male member), such free play may be a maximum of 30 degrees. The number of degrees may vary with the number of points/flutes of the spline of the reaction portion. The associated loss in tension will be different for every joint, depending on the thread pitch, grip length, and relative stiffness'. Note that in non-‘friction-type’ joints, transmitted loads are not dependant on the friction between the clamped surfaces, and thus tension is not as important as ensuring that disassembly is prevented.

Embodiments of the present invention include a threaded male member for a fastening arrangement, the threaded male member including at least one reaction portion at or towards at least one respective end of the threaded male member for use in reacting applied torque during tightening or releasing of an associated nut of the fastening arrangement.

The at least one reaction portion is arranged and configured such that it can withstand the full tightening (counter-) torque of the associated nut.

The threaded male member may have opposed first and second ends. A said reaction portion may be provided at or towards each of the first and second ends, or at or towards one of the first or second ends.

At least one of said reaction portions is capable of withstanding the full tightening torque or counter-torque of the associated nut.

It will be appreciated that the respective reaction portion provides a permanent feature of (i.e. integral to) the threaded male member that is arranged and configured not to shear-off the threaded male member (e.g. under full application or removal torque).

The threaded male member having permanent reaction portion is therefore available as part of a permanent anti-rotation system, such as when an anti-rotation cap or spring clip is applied after the joint is tightened and/or for use when the reaction portion is needed for removal of a tightened nut e.g. removal of a plain nut.

The respective reaction portion(s) can be utilised for tightening and release of the relevant fastener arrangement. Because the reaction portion(s) is/are not in the load path (i.e. do not provide an active tension feature within the fastened joint once tightened), the threaded male member incorporating such reaction portion(s) can be more readily accepted as a replacement for or be complementary to current approved fastening systems, such as plain nut and threaded rod arrangements, whilst providing a tightening/release torque reaction capability for use with counter-acting socket tools.

The threaded male member may include one continuous helical thread or multiple helical threads separated by a shank portion and having the same handedness throughout. The threaded male member may be formed from all-thread.

A said reaction portion may be provided at or towards each of opposed first and second said ends.

To tighten conventional nut and bolt fastening systems, torque is applied to the nut and is reacted by the bolt head. The resulting torque couple is between the ends of the fastening system (i.e. across the “grip length”).

The at least one reaction portion of the respective threaded male member includes a primary reaction portion.

The threaded male member may include a primary reaction portion, which may include at least one spline, at least one groove, channel, flute or recess in a portion of the thread of the threaded male member, or a combination of any two or more thereof. At least one of said at least one spline, at least one groove, channel, flute or recess in a portion of the thread of the threaded male member, may be provided on an external surface at or towards one end or both opposed ends of the threaded male member. The at least one reaction portion may include at least two independently accessible said reaction portions at a same end of the threaded male member. At least two said reaction portions may include the primary reaction portion and a secondary reaction portion. The secondary reaction portion may include at least one of an internal cavity, a projection, a slot, a secondary spline, a polygonal shaped recess or other engageable structural feature at an end of the threaded male member, or a combination of at least two thereof. The primary reaction portion and the secondary reaction portion may be within an outside diameter of a thread of the threaded male member. The threaded male member may be configured to threadingly receive thereon a respective female threaded fastener at each of opposed ends of the threaded male member.

Embodiments of the present invention apply torque to the nut that is reacted by a reaction portion, such as a spline, at an end of a threaded male member (such as a bolt, threaded male member or threaded rod). The resulting torque couple is at one end of the spline. The torsional stress induced along the body of the bolt in the conventional fastening system compared to the torsional stress induced in the threaded male member of embodiments of the present invention, which threaded male member is also under tensile stress, can differ between the two tightening scenarios.

Testing fastener arrangements of embodiments of the present invention has shown higher tensions of the bolt are possible before failure when compared to a conventional fastener. It may be surmised that, at least as observed by the aforementioned testing, the reduced torsional stresses in the grip-length have allowed increased tension stresses to be carried by the threaded male member before failure. Such potential for withstanding higher tension than the conventional fastening system could therefore potentially alter the fastener's statistically preferred tensile failure mode (shaft snapping) instead of thread stripping.

The design intent of threaded fastener arrangements/assemblies with threads in accordance with ISO 68-1 is such that, under static tensile overload, the thread stripping failure mode is prevented. Bolt breaking (i.e. snapping) is the preferred failure mode since it indicates the full load-ability of the nut and threaded male member (e.g. bolt) and has an ‘almost certain’ detection rate. That is, this failure mode is very obvious to an operator, as opposed to thread stripping which may be hidden, so not readily observable. As such, it is considered desirable to maintain an accepted high standard ‘almost certain’ detection rate when adopting embodiments of the present invention.

One or more embodiments to achieve this, whilst potentially changing the probability of stripping vs snapping the threaded male member/bolt, a failure “fuse” may be implemented into the spline/reaction tip to indicate an operator observable failure before thread stripping can occur.

A failure mechanism (e.g. akin to a ‘fuse’) is preferably readily detectable, such as by observance by personnel/operators, and may be embodied by a shearing of the reaction portion from the threaded male member. Like snapping the threaded male member, this failure would indicate an issue with the tightening process, requiring review and remediation including, but not limited to, a re-installation of the fastener arrangement.

The threaded male member may include the reaction portion and a shear portion at one or both ends of the threaded male member, wherein the threaded male member retains a said reaction portion after removal of said shear portion. The retained reaction portion can be used to remove the nut from the threaded male member as part of the remediation process. Said respective shear portion can shear off the threaded male member during tightening of a nut on the threaded male member.

On a threaded male member have a reaction portion at each distal end, one of the reaction portions of the threaded male member may have a shear portion arranged and configured to shear/shear off at a threshold tightening torque to indicate that a required torque has been achieved. The threaded male member may include a predetermined weakness and/or thickness of material to assist such shearing. According to one or more embodiments, the other of the reaction portions is adapted to be a permanent feature of the threaded male member wherein a failure of this reaction portion would signify a failure of the bolting process in that an excessive torque has been applied to the joint and a remediation process is required. The shear portion is preferably arranged and configured to shear from the threaded male member when at or above a threshold torque applied to the shear portion.

The threaded male member may be a permanent or semi-permanent fixed stud, such as a wheel stud or anchor stud.

The at least one reaction portion may be provided on an external surface of the threaded male member, or internally within a hollow or recess into a respective said end of the threaded male member, or both externally and internally of the respective end of the threaded male member.

The reaction portion may include a spline. The spline being tool engageable and able to react at least the same torque as will be applied to the associated nut for final assembly.

At least one said reaction portion may be adapted to withstand at least a maximum installation and/or removal torque of an associated nut on the threaded male member. At least one said reaction portion may be adapted to remain functional as said reaction portion(s) after installation of the threaded male member e.g. after tightening of the respective nut(s) to required torque.

According to a further aspect of the present invention, a fastening arrangement includes a threaded male member as defined according to one or more embodiments herein and at least one nut including a first nut, wherein a torque is applied on the first nut and a counter-torque is applied on the reaction portion at one said end of the threaded male member.

The at least one nut of the arrangement may include a second nut, the first and the second nut for fastening a work-piece therebetween.

The at least one nut may be prevented or restricted from rotation relative to the threaded male member by a locking device or thread-lock.

The locking device preferably includes a cap or resilient device. The resilient device may include a spring arrangement for resiliently retaining the locking device to the threaded male member/nut

Preferably the locking device engages with the respective reaction portion and the respective nut, such as at the same end of the threaded male member.

The locking device may have angular free-play between the reaction portion and the locking device interface, and between the nut and the locking device interface, allowing the locking device to be installed on the threaded male member and nut irrespective of an angular relationship between the reaction portion and the nut.

The threaded male member may be configured as a permanent or semi-permanent (‘fixed’) stud arranged to threadingly receive said at least one nut at one end only thereof.

The threaded male member may include a spline or other engagement feature to engage with a body to prevent relative rotation of the threaded male member with respect to the body.

It will be appreciated that the threaded male member, such as a wheel stud, according to one or more forms of the present invention need not have a spline or other engagement feature.

A threaded male member for use as a wheel stud having the reaction portion of the present invention and without a spline can be stronger compared to a stud with a spline as it does not have stress raising edges of the spline.

A plain shank can be used instead of the spline (preferably with an interference fit to prevent the stud being pushed or falling out e.g. as sockets of a tool are brought into contact unless it had some axial retention).

The fixed stud may be a wheel stud for mounting a wheel rim to the body being a wheel hub of a vehicle.

The reaction portion of the wheel stud may receive an anti-rotation device, such as a spring clip or cap/cup after final tensioning of the associated nut.

The at least one nut may include at least one segmented nut.

A further aspect of the present invention includes a fastener system having a fastener arrangement including a threaded male member having at least one reaction portion, at least one nut for threading engagement with the threaded male member, and a torque application tool for tightening or releasing the at least one nut on the threaded male member.

The tool may include at least two sockets including a first socket for engagement with the reaction portion and a second socket for engagement with a said nut.

The nut may include a segmented nut, and the tool includes a said socket for engagement with an inner nut of the segmented nut and another said socket for engagement with a sleeve of said segmented nut.

The fastener system may include at least one anti-rotation means to prevent or restrict relative motion of a nut and the threaded male member.

The anti-rotation means may include a locking device and/or thread-lock. The anti-rotation means may include at least one cap or resilient device.

The locking device can be engaged with a rear said nut and the threaded male member when the tool is applying torque to a front said nut and the threaded male member.

A further aspect of the present invention provides an anti-rotation device for restricting or preventing relative rotation of a fastened nut and threaded male member arrangement.

The anti-rotation device may engage, in use, with a reaction portion of the threaded male member and with the nut to prevent or restrict relative rotation of the nut and the reaction portion.

The anti-rotation device may include a cap which, in use, at least partially covers the nut.

The anti-rotation device may include resilient biasing means arranged and configured to, in use, engage with the reaction portion and a nut. The resilient biasing means may include a spring clip.

Embodiments of the present invention provide a method of preventing or restricting relative rotation of a nut on a threaded male member of a threaded male member fastener arrangement, the method including having an anti-rotation means engaged with the nut and with a torque reaction portion of the threaded male member.

The anti-rotation means may include a cap or a resilient device applied to engage with the nut and with the reaction portion.

The anti-rotation means may engage on the reaction portion and engages with at least one face of the respective nut.

Related disclosures within patent applications of the present applicant, published as WO2018126297A1, WO2016094953A1, and in unpublished patent application AU2020903063, are each herein incorporated by reference in their entirety.

One or more forms of the present invention provides a tool arrangement for: 1. installation of fasteners for tensioned joints; and/or 2. release/removal of such fasteners, with all torques (e.g. as may be required for a fastener to be sufficiently/fully tightened or sufficiently/fully loosened) being reacted within a closed system of drivers/drive sockets. This eliminates the need to use an external reaction arm to counter the torques required either during tensioning or removal of the fastener.

It will be appreciated that the tool arrangement encompasses a tool system, a multi-function tool or a combination of separate tools/tool heads/sockets that can be interchanged as required dependent upon the application at hand. For example, the tool arrangement may include a driver or handle (which may be powered or manual) with interchangeable, selectable or adaptable tools for applying and releasing a nut type fastener.

One or more embodiments of the present invention provides a tool arrangement for engagement with a fastener assembly, the fastener assembly having inter-engageable male and female fasteners, the male member having a reaction portion at an end that will receive a female fastener wherein the female fastener includes at least two parts configured to move relative to one another for release of the female fastener; wherein, for at least part of installation of the female fastener on the male fastener, the tool arrangement engages with and provides a torque to the female fastener and the tool arrangement engages with and the reaction portion and reacts a counter-torque through the male fastener; and wherein, for release of the female fastener from the male fastener, the tool arrangement engages with and reacts counter-torque through a said part of the female fastener which moves relative to at least one other said part of the female fastener.

It will be appreciated that the installation counter-torque can be reacted directly through the male fastener, which male fastener may have or be a threaded male member, such as a threaded bolt, threaded stud, threaded shaft or threaded rod.

The removal counter-torque may be reacted directly to a part of the female fastener which can move in the opposite direction to another part of the female fastener.

Alternatively, removal counter-torque may be reacted to the male fastener (e.g. threaded male member) reaction portion.

The female fastener can include a nut having a sleeve or collar retaining together segments of an inner nut member when the nut is assembled for installation and allowing relative movement of the segments when released by the sleeve or collar.

One or more embodiments of the present invention provides a tool arrangement including at least three concentric engagement portions.

The at least three engagement portions may respectively engage with portions of a female fastener and part of a male fastener.

Preferably the tool arrangement includes at least three coaxial sockets. For example, at least three concentric sockets as part of a single tool (e.g. integrated into the same tool).

Preferably the at least three sockets are driven by selection from at least two drives.

Drive from at least one of the drives to the respective socket is preferably user selectable.

The tool arrangement may include a first socket drive arranged and configured to drive the first socket, a second socket drive arranged and configured to drive the second socket, and a drive to said third socket is selectable or not engaged to drive said third socket at all or until selected.

The tool arrangement may include a said second socket drive arranged and configured to drive said second socket, and a said third socket drive arranged and configured to drive said third socket, and said first socket drive to said first socket is selectable or not engaged to drive said first socket at all or until selected.

Preferably the tool arrangement includes selection control to select driving the first and second sockets or driving the second and third sockets.

A mechanism or control feature of the tool arrangement may be provided that relieves counter-torques developed during installation and/or tightening of the female fastener.

The second reaction means may include the second and third portions, which may respectively be or include sockets that apply the counter-torques.

Drive to the first and second sockets may be in concert such that the first and second sockets rotate together.

The tool arrangement may have:
first reaction means to release the female fastener; and
second reaction means to install the female fastener of the fastener assembly.

The tool arrangement may include the first reaction means having sleeve/collar (first) and inner nut member (second) engagement portions arranged and configured to respectively engage with the sleeve/collar and the inner nut member and provide counter directional torques (such as clockwise and counter-clockwise) for rotation of one of the portions relative to another of the portions to release the female fastener or nut from the male fastener or threaded male member.

The tool arrangement may include the second reaction means having nut (second) and threaded male member (third) engaging portions arranged and configured to respectively engage with an inner nut member of a segmented nut and the threaded male member onto which the nut is threaded and provide counter directional torques (such as clockwise and counter-clockwise) to the inner nut member and the threaded male member to threadingly advance or reverse the segmented nut along the threaded male member.

The first and the second reaction means may be provided as separate tools. Alternatively, the first reaction means and the second reaction means may be provided in a single (combination) tool.

One or more embodiments of the present invention may be provided as a tool system incorporating at least one of, preferably both of, the first reaction means and the second reaction means.

The first reaction means and the second reaction means may be selectively engageable, such as a single tool having a selection mechanism allowing selection of one or the other of the first and second reaction means.

It will be appreciated that the second reaction means (used to install/tighten the nut) need not be available or functioning for release of the nut by the first reaction means.

The first reaction means need not be available or functioning for installation of the nut by the second reaction means. Preferably the first reaction means and the second reaction means are axially aligned, such as in a single (combination tool).

The first reaction means and the second reaction means may each be provided as distinct tools, such as one selectively replacing the other on a driver device or both reaction means (first and second) provided on different parts of a driver device. For example, the first reaction means can be provided on one side and/or end of a driver device, and the second reaction means can be provided on another side and/or end of the driver device.

The driver device can be electrically (mains or battery) powered, hydraulically powered or pneumatically powered.

The sleeve/collar engagement portion and the inner nut member engagement portion may be rotationally orientated with respect to each other to respectively engage with the sleeve/collar and the inner nut member. For example, the sleeve/collar engagement portion and the inner nut member engagement portion may be indexed to align with each other, and therefore with the assemble nut to fit onto the assembled nut (such as when tightened but prior to release).

The sleeve/collar engagement portion and the inner nut member engagement portion may have positive indexing, such as at least one marker, at least one detent, at least one ratchet mechanism, or a combination of two or more thereof, which may provide a positive ‘click’ or feel for a user when the sleeve/collar engagement portion and the inner nut member engagement portion are correctly aligned.

The sleeve/collar engagement portion and the inner nut member engagement portion may be rotationally biased to orientate with respect to one another. For example, such rotational bias is provided by a biasing means, such as at least one detent mechanism, spring or other resilient member.

The sleeve/collar engagement portion and the inner nut member engagement portion may be provided with a rotation limit with respect to one another such that relative rotation of the sleeve/collar and the inner nut member of the segmented nut is limited by the rotation limit.

The rotation limit may allow relative rotation of the sleeve/collar and inner nut member from an assembled orientation to a release orientation. The rotation limit is preferably an angular limit between 5° and 20°, preferably between 10° and 20° and more preferably at or about 15°.

Generally, the rotation limit is determined so that it places the outer release sleeve at or near the optimum angle to achieve release of the inner nut and avoids under or over rotation of the outer-sleeve with respect to the inner nut. The rotation limit may include a physical stop or may be a position at which the inner nut member and sleeve/collar are aligned such that the segments can move radially outward and release their engagement from the threaded male member. By way of example, see angles α and β represented in FIG. 24A, where angle β is at or about 15° to allow the segments to move radially—see FIG. 24B.

The sleeve/collar engagement portion and the inner nut member engagement portion may rotationally engage to a threshold torque with the respective sleeve/collar and inner nut member prior to relative rotation sleeve/collar and inner nut member to release the nut.

Embodiments of the present invention may include a method of tightening a fastening arrangement having a threaded male member and a female fastener with an internal thread to threadingly receive the threaded male member, the method including applying a torque to the female fastener and a counter torque to the threaded male member, sensing a change in a rate of change in torque (ΔT) applied to the fastening arrangement relative to a change in rate of change of angle (ΔA) of rotation of the female fastener or the threaded male member, and determining that tightening of the fastening arrangement is at a required torque value when the sensed change in the rate of change of torque relative to the rate of change of angle reduces.

The tightening of the fastening arrangement may be determined to be at a required tension value when the sensed change in the rate of change of torque relative to the rate of change of angle reduces by a predetermined amount. The predetermined amount may be a predetermined percentage of a maximum rate of change of torque relative to the rate of change of angle applied during the fastening. The predetermined percentage may be between 10% and 90%, preferably between 20% and 80%, more preferably between 30% and 70%, more preferably between 40% and 60%, and preferably around 50% of the maximum torque applied during the fastening.

One or more embodiments of the present invention provides a tool arrangement for use in installing or releasing a segmented nut from a threaded male member (such as a bolt, threaded stud, threaded shaft or threaded rod), the segmented nut including multiple inner segments and an outer sleeve, the tool including:
a first portion configured to engage with at least part of the sleeve,
a second portion to engage with at least one segment of the inner nut member, and
a third portion to engage with a reaction portion of the threaded male member, wherein, for releasing the segmented nut, the tool has selective engagement of the first portion with the at least part of the sleeve and the second portion with the at least one segment, for relative rotation of the sleeve and the inner nut member; and wherein, for tightening the segmented nut, the tool has selective engagement of the second portion with the at least one segment and the third portion with the reaction portion of the threaded male member, allowing relative rotation of the segmented nut and the threaded male member.

One or more embodiments of the present invention provides a fastener system including a fastener assembly incorporating a segmented nut and a threaded male member (such as a bolt, threaded male member, threaded male member or threaded rod), the segmented nut and threaded male member arranged and configured to threading engage together, and the aforementioned tool, the tool being for:
selective engagement with an outer sleeve of the segmented nut and an inner nut member having multiple segments to release the segmented nut, and/or
selective engagement with the inner nut member and an engagement portion of the threaded male member for tightening of the segmented nut.

One or more of the first portion, the second portion and the third portion may be arranged and configured to move rotationally and/or longitudinally with respect to one to at least one other of the first portion, second portion and third portion relative to a central axis of the tool. For example, for release of a segmented nut, the tool may provide for relative sliding motion of the first portion with respect to the second portion and/or the second portion relative to the third portion.

It will be appreciated that each of the first, second and third portions may be arranged and configured to move relative to at least one other of those portions. Such movement is to be understood to encompass at least one of the portions remaining fixed, such as to a tool body or drive mechanism, and the other portions arranged and configured to move relative to that fixed portion.

The relative movement of at least one of the first, second and third portions may be powered, such as by a drive means, or may be manual, such as by manual operation of a user. Such powered or manual operation may be selectable between powered and manual operation, such as by a selection control, which may be provided on the tool or on the drive means.

The tool may be permanently attached to a drive means or may be releasably attachable to the drive means.

The drive means may be electrically powered (mains supply, portable/generator supply or battery supply), mechanically powered, hydraulically powered or pneumatically powered. For example, the tool drive may be provided by an electric driver having a body, an electric motor and a drive output to power the tool.

The drive means may include a selection mechanism to selectively move one or more of the first, second and third portions for selective respective engagement of the tool with the fastener and/or the reaction portion of the threaded male member.

One or more embodiments of the present invention may include a torque multiplier. For example, one or more embodiments of the present invention may include or be releasably connectable to gearing/a gearbox between a drive means (electric motor, pneumatic or hydraulic drive) and one or more of the reaction means and/or reaction sockets. The torque multiplier may include multiple selectable gear ratios. For example, for relatively higher torque low speed rotations, the tool/tool arrangement may have a first gear ratio selected through the gearing/gearbox, and for relatively lower torque higher speed rotations, the tool/tool arrangement may have a second gear ratio selected through the gearing/gearbox. Further ratios may be selected/provided using a number of gear ratios provided through the gearing/gearbox. One or more of gearing, gear ratios, gearbox or torque multiplier may be mechanically, electrically or electro-mechanically switchable/selectable between gears/ratios/torque multiplier ratios.

The tool may include at least one clamp arrangement arranged and configured to grippingly/clampingly engage with at least one of the sleeve/collar, inner nut member segment(s) and/or reaction portion of the threaded male member. Preferably the clamp arrangement is configured to grippingly/clampingly engage with a reaction portion of the threaded male member. In such case, preferably the reaction portion of the threaded male member is the proximate threaded end of the threaded male member (and may form part of the continuous thread of the threaded male member). The reaction portion can be self-forming.

Such clamp arrangement may be provided in conjunction with movement means for relative longitudinal movement of at least one of the first, second and third portions of the tool.

Such clamp arrangement may operate on rotation of the respective first, second or third portion and/or as driven by the drive means. Such clamp arrangement can assist in positive engagement of at least one of the first, second and third portions with its respective sleeve/collar, inner nut member segment(s) and reaction portion of the threaded male member.

The reaction portion of the threaded male member may shear off at a threshold tightening torque. The shearing off could be used to indicate that the segmented nut is tightened to a required or minimum threshold torque. The threaded male member may include a predetermined weakness and/or thickness of material to assist such shearing.

Alternatively, the reaction portion could be left on the threaded male member after tightening of the segmented nut.

A Ground Engaging Tool (GET) application may leave the reaction portion of the threaded male member in place during the installation process, and the reaction portion may be worn away (such as by abrasion) in use.

The reaction portion provides a counter rotation torque or “wrenching” ability to the threaded male member to react against rotational force (torque) applied to the inner nut member. That is, the reaction portion is a feature of the threaded male member that allows a torque to be applied to the threaded male member by the tool.

The reaction portion may include an external portion of the threaded male member, an internal portion of the threaded male member or a combination of such external and internal portions.

An external reaction portion may be provided via longitudinal slots/flutes in the (male) threaded male member and the thread of the threaded male member is continuous or provides a helical thread with its continuity interrupted by the slots/flutes along the reaction portion. The flutes may be partial or along the full length of the threaded male member (whether a bolt, stud or threaded bar, and whether or not threaded all the way along the shaft or having one or more plain shank portions or other features).

The reaction portion may include a socket (e.g. an internal cavity) for receiving part of the tool. The socket may be of regular shape, such as square, hexagonal or hexalobular.

Alternatively, the reaction portion may include an external head, such as a square drive or hexagonal drive head. Further alternatively, the reaction portion may include a combination of socket and head arrangements. The reaction portion may be or include a (normal) part of the threaded male member. It will be appreciated that the reaction portion may extend beyond a threaded portion of the threaded male member. That is, the threaded portion of the shaft may stop short of an end of the threaded male member and the reaction portion may continue beyond the end of the threaded portion. The reaction portion may be connected to the threaded portion by a weak zone such that the reaction portion shears off the threaded portion upon application of excessive torque causing a failure which provides a visual indication to the operator that remediation action is required.

In a reaction portion arrangement incorporating only an internal socket, the socket may extend into a threaded portion of the threaded male member. That is the threaded male member may have the thread external on the respective shaft and the socket extending internal of that portion of the shaft. The overall length of the threaded male member can therefore be shorter than arrangements having an external reaction portion.

Also, as increasing torque is applied by the second engagement portion of the tool to the inner nut member, the inner nut member can provide reinforcement support to the cavity portion of the threaded male member where that cavity portion of the threaded male member is adjacent the inner nut member when the segmented nut is threaded onto the shaft.

Preferably, the cavity/socket is at least partially within the inner nut member when the fastener assembly is fastened but at least 3, preferably 5 or more, thread pitches above a bearing face of the segmented nut with respect to the work piece.

Preferably, the cavity/socket extends no deeper into the threaded male member than an upper extent of the outer sleeve (height of the sleeve) away from the bearing face of the segmented nut.

The tool may include grip means that grips an end portion of the threaded male member, such as at the final thread pitches on the shaft or a plain end of the shaft if the thread pitches stop short of the end e.g. once the segmented nut has been run along the thread to expose an end of the threaded male member passing through the segmented nut. For example, the grip means may include multiple engagers that together grip the end portion of the shaft e.g. 3 teeth/jaw chuck, that radially inwardly grip, preferably bite into, the bolt shaft, and react the segmented nut torque against that grip.

Preferably the at least one of the multiple engagers permanently deforms the threaded male member so that the segmented nut may not unwind along the thread. Whereas, damage caused to that end of the threaded male member would otherwise be a significant problem if a standard solid nut was used (as it would not allow the nut to be removed), when using the segmented nut, such damage to the end of the shaft it does not prevent the segmented nut being released by outer-sleeve and radial release of the segment. The damage to the thread(s) of the shaft can also be beneficial as it locks the assembled segmented nut onto the threaded male member i.e. preventing complete unwinding and loss of the segmented nut.

In cases where the end of the threaded male member is not eroded or broken off during use, there is also the capacity to re-tension the fastener assembly using the same process again. The damage pattern on the threaded male member may also act as visual confirmation that the joint has been tensioned.

Engagement of the tool with the reaction portion of the shaft may not be possible where the nut is initially threaded onto a starting thread of the threaded male member because the threaded male member may not at that initial engagement be sufficiently exposed from the nut, particularly in the case that the reaction bit is an external feature of the threaded male member.

Therefore, a fourth portion of the tool may be provided to engage with an end portion of the threaded male member. The fourth portion can provide a reaction torque before the third reaction portion engages with the reaction portion of the threaded male member.

The end portion of the threaded male member may include an engagement portion, such as an opening (e.g. a blind recess or open ended recess, square or hexagonal socket, single slot, cross, star etc.) to receive the fourth portion of the tool for releasable engagement therewith. For example, the end portion may be in an end of the reaction portion of the threaded male member.

One or more embodiments of the present invention may include the fourth portion may be biased to engage with the engagement portion.

For example, the tool may include a resilient means, such as one or more springs, to engage and/or disengage a driver of the fourth portion with the opening.

Preferably, the driver, in use, engages with the opening to provide an initial counter torque to allow the nut to be applied. Once the nut is sufficiently threaded (‘run-down’) along the thread of the threaded male member, the reaction portion of the threaded male member becomes accessible (e.g. sufficiently exposed from the inner nut member) to the tool and the fourth portion can engage the end of the reaction portion of the threaded male member to provide the counter-torque to subsequently fully apply the nut along the thread as required.

It will be appreciated that mention of the reaction portion of the threaded male member need not limit the reaction portion to itself being threaded. The reaction portion may include one or more threads or partial threads or no thread.

With regard to partial thread, the reaction portion may, for example, be square or hexagonal, and may have partial threads around a periphery thereof so that the nut can thread along the reaction portion even though the nut is not threadingly engaged with a complete thread. The partial thread is sufficient for initial ‘winding-on’ of the nut, and the nut subsequently full threadingly engages with a full thread of the threaded male member.

To limit torque load on the fourth portion of the tool, the fourth portion may include a torque limit mechanism. The torque limit mechanism may include a ratchet and/or a clutch limiting the amount of torque that the fourth portion can transmit. At or above a torque limit, the torque limiter releases the torque, or does not allow torque to increase, that would otherwise be transmitted through the fourth portion.

The tool may permit a certain amount of twist to occur on the driver in case of any lost motion/back-lash, such that it would effectively allow increasing torque to be taken up by full engagement of the third portion with the reaction portion of the threaded male member.

Preferably, the tool allows an amount torque to be transmitted via the fourth portion, such as a driver, in case of any lost motion/back-lash such that it would effectively allow increasing torque to be taken up by the third portion engaging with the reaction portion of the threaded male member.

The relationship between the engagement portion and reaction portion are in an indexed relationship so that the 4th driver and 3rd driver can engage with the respective engagement portion and reaction portion without clash occurring.

The first portion (that engages with the sleeve or collar of the nut) may include at least one external clearance region that allows the tool to fit over and engage with a nut that is relatively close to another nut in situ or other fixed feature.

The at least one clearance region may include an opening and/or a recess of the first portion.

The clearance region may extend partially or completely around a periphery of the first portion, that allows the first portion to engage over the sleeve or collar (e.g. for release of the nut) without interference with an adjacent fixed feature or other nut that would otherwise, in absence of such a clearance region, interfere with the operation of the tool.

The at least one clearance region may be continuous (e.g. all the way around the periphery) or may be discontinuous (multiple portions/sections) or may be at one zone of the first portion.

Preferably the at least one clearance region is provided at or adjacent an open end of the first portion. For example, in the sense that the first portion includes a socket type component, the at least one clearance region is provided at or adjacent the periphery of such a socket (e.g. the exterior of the ‘skirt’ of such a socket or at a distal end thereof). The at least one clearance region may be forged or machined in the first portion.

It will be appreciated that the tool may include a thread engager to engage with the thread of the threaded male member. Preferably the thread engager is provided as part of or working in association with the third portion of the tool. The thread engager may include at least one, preferably multiple, thread engagement portions.

One or more of the at least one thread engagement portion may, in use, intentionally distort, deform or damage the thread of the threaded male member, such as at or adjacent an end of the thread of the threaded male member adjacent the reaction portion of the threaded male member.

The thread engager may include a chuck arrangement. For example, the at least one engagement portion may be configured to move radially inward to engage the thread. The chuck arrangement may include a mechanism that moves the at least one engagement portion inwards, such as by a cam arrangement or inclined plane, cone, thread, or combination of any two or more thereof.

The thread engager may include the cam arrangement, whereby, in use, the at least one thread engagement portion moves relative to a body of the third portion and increases, through the camming action, engagement with the thread.

Preferably the at least one engagement portion increases inwardly directed force on the thread as the body of the third portion tries to rotate relative to the reaction portion in response to the counter-torque applied by the second portion on the inner nut member.

Damage to the thread of the threaded male member by the engager helps to prevent unwinding of the segmented nut from the threaded male member and/or can provides a visual indication that the nut is tightened to at least a threshold toque. That is, the amount of or presence of damage to the thread by the engager can be used to provide a visual indication that the nut is tightened and/or that the nut cannot completely unwind form the threaded male member.

One or more embodiments of the present invention can include selective engagement between the first and second portions and the second and third portions. Preferably, when the first and second portions are operatively engaged together, the third portion is disengaged from the second portion. When the second and third portions are operatively engaged, the first portion is disengaged from the second portion. Such selective engagement may be provided by a selective engagement means, which may be provided, for example, as a clutch and/or ratchet mechanism.

One or more forms of the present invention includes features configured to accommodate sideways thrust loadings between the first portion and the second portion of the tool/tool arrangement (for example, 1st and 2nd sockets that are designed to engage respectively with the sleeve/collar and inner nut member of the female fastener/segmented nut). Such features can mitigate against binding when the female fastener/segmented nut has uneven wear through use (such as impact or abrasion damaging or wearing down part of the female fastener/segmented nut).

One or more embodiments of the present invention includes features configured to accommodate axial/longitudinal thrust loadings between the first portion and the second portion of the tool/tool arrangement (for example, 1st and 2nd sockets that are designed to engage respectively with the sleeve/collar and inner nut member of the female fastener/segmented nut). Such features can mitigate against “camming off” when the female fastener/segmented nut has uneven wear through use (such as impact or abrasion damaging or wearing down part of the female fastener/segmented nut).

One or more features of one or more embodiments of the present invention assist(s) with ensuring that side thrusts are absorbed without binding. There can also be a “camming off” effect where the second portion (e.g. the second socket on the inner nut member) may want to push the tool off during torque application. The first portion (engaging with the sleeve/collar) will tend to counter this, but a longitudinal thrust capability can be provided by the first and/or second portions to ensure no or minimal binding. Again, prior art concentric sockets have not had to provide for such thrusts.

The tool arrangement may feature one or more bearings/bearing arrangements (such as ball, taper rollers or plain bearings) to accommodate axial or radial reactions from a malformed, partially formed or damaged nut profile.

When concentric reaction means are assembled on inner nut member and outer nut member; or inner nut member and threaded male member, eccentric profiles or angled faces may generate some force in either axial, radial, or both directions, which would cause binding. Furthermore, if no longitudinal reaction existed between reacting members, one or more may move longitudinally in such a way that it is no longer in contact.

Tightening of conventional bolt type fastening systems is conducted either by the ‘torque-method’ or the ‘angle-method’, both being accepted terms of art and do not need further elaboration.

The ‘torque-method’ involves tightening until a predetermined torque is reached. The ‘angle-method’ involves tightening to a predetermined ‘snug’ torque and then tightening to a predetermined angle from the ‘snug’ position. Both these methods require an amount of knowledge about the joint before installation to ensure that the ‘predetermined parameters’ are sufficient to ensure the correct tension is achieved.

Snug tight is defined by the Australian Industry and Skills Committee (AISC) and the Research Council on Structural Connections (RCSC) as when all the plies in a connection have been pulled into firm contact by the bolts in the joint, and the bolts have been tightened sufficiently to prevent removal of the nuts without a wrench. It is noted that no specific level of installed tension is required to achieve this condition, which is commonly attained after a few impacts of an impact wrench or the full effort of a worker with an ordinary ‘spud wrench’. The plies should be in firm contact, a condition that means the plies are solidly seated against each other, but not necessarily in continuous contact. There is no upper limit to the pretension that can be present in a snug-tightened joint.

The tool arrangement may include a tool having at least two concentric portions, including an outer concentric portion and an inner concentric portion, wherein the outer of the two concentric portions is configured to engage with a sleeve of a segmented nut and the inner concentric portion is configured to engage with a portion of a threaded male member, wherein the outer concentric portion moves the sleeve to a release position relative to an inner nut of the segmented nut, and the outer concentric portion continues to rotate and engage with the inner nut and thereby rotate the segmented nut relative to the threaded male fastener.

A preferred method of tightening would enable tightening such that threaded fastening systems (such as including bolts) could be fully tensioned without requiring knowledge such as the joint friction, stiffness, grip length, or a requirement to achieve snug tightness as a necessary step to achieving the desired final joint tension.

One or more embodiments of the present invention provides a method of tightening a fastening system including a threaded male member and at least one female fastener for receiving the threaded male member includes detecting a reduction in rate of change of torque vs angle of rotation of the female fastener relative to the threaded male member when the fastening system transitions from elastic to plastic strain.

The detection of such reduction of torque vs angle of rotation of the female fastener relative to the threaded male member indicates the completing of the tightening.

Embodiments of the present invention provide a method or tool for applying the torque to the fastening system wherein the torque or tool may be stopped when the reduction or sufficient said reduction is detected.

The reduction in rate of change of torque vs angle required to indicate the end of the tightening may be modified to reduce probability of the detection of the end of the tightening being incorrectly triggered.

For example, FIGS. 18A and 18B show an example of a 50% reduction in rate of change in torque vs angle (ΔT/ΔA) before the tightening is stopped. A 100% reduction is less likely to be triggered prematurely, reaching the desired tension but resulting in more plastic deformation within the joint.

Embodiments of such a method of the present invention ensure that a reduced or minimum tension required for full tensioning is exceeded, but tightening is stopped before significant yielding or failure of the threaded male member occurs. This may be achieved without the operator referencing bolt lengths or first tightening to snug.

The operator input to such system would be a preferred percentage reduction from the peak rate of change of torque versus angle to signify the completion of assembly of the joint/fastening arrangement.

### BRIEF DESCRIPTION OF THE DRAWINGS

One or more embodiments of the present invention will be described with reference to at least some of the accompanying Figures, in which:

FIG. 1 shows a threaded male member used in fastening a flange joint using standard nuts, the threaded male member having a reaction portion at one end thereof according to an embodiment of the present invention.

FIG. 2 shows a threaded male member used in fastening a flange joint using standard nuts, the threaded male member having a reaction portion at each opposed end thereof according to a further embodiment of the present invention.

FIG. 3 shows a threaded male member used in fastening a flange joint using alternating standard and segmented nuts, the threaded male member having a reaction portion at one end thereof according to an embodiment of the present invention.

FIG. 4 shows a threaded male member used in fastening a flange joint using alternating standard nuts and segmented nuts, the threaded male member having a reaction portion at each end thereof according to an embodiment of the present invention.

FIGS. 5A, 5B and 5C show examples of locking devices (such as a locking cap or locking spring device) applied to a respective reaction portion of the threaded male member to prevent relative rotation of the threaded male member and the respective nut.

FIG. 5D shows locking devices applied at each opposed end of the threaded male member, according to a further embodiment of the present invention.

FIGS. 6A and 6B show, by way of example, a flange joint including a fastening arrangement using a threaded male member according to an embodiment of the present invention with a locking device applied at one end and a torque socket arrangement applied to a segmented nut and reaction portion of a threaded male member at the other end.

FIGS. 7A to 7G show alternative configurations of the threaded male member according to embodiments of the present invention.

FIGS. 8A to 8C show examples of an external reaction portion of a threaded male member with longitudinal slots/flutes in the (male) threaded male member according to an embodiment of the present invention.

FIGS. 9A to 9D show various arrangements of secondary reaction portions according to embodiments of the present invention.

FIGS. 10A to 10B show an arrangement for a reaction portion sized so that a socket can access the reaction portion through a nut, according to an embodiment of the present invention.

FIGS. 11A to 11D show examples of an integral (‘designed in’) fail region in a reaction portion/end of a threaded male member, according to embodiments of the present invention.

FIGS. 12A to 12C show alternative embodiments of structural/integral fail regions of a threaded male member for use in indicating an over-torqued failed tightening procedure, according to embodiments of the present invention.

FIGS. 13A to 13H show examples of an anti-rotation device according to embodiments of the present invention.

FIGS. 14A to 14C show an embodiment of an anti-rotation device according to an embodiment of the present invention.

FIGS. 15A to 15C show an alternative arrangement for an anti-rotation device according to a further embodiment of the present invention.

FIGS. 16A to 16D show alternative embodiments of the present invention for bolting of wear plates. FIGS. 16A and 16B show an embodiment using a cylindrical bolt head. FIGS. 16C and 16D show an embodiment using a tapered seat bolt head.

FIGS. 17A to 17E show examples of a threaded male member according to embodiments of the present invention applied as a fixed stud, such as a splined or non-splined (plain shank) wheel stud, for mounting a wheel rim to a wheel hub of a vehicle.

FIGS. 18A and 18B show charts of torque vs angle and rate of change of torque with respect to the rate of change of angle for the tightening of a bolted joint, representing an embodiment of a dynamic tightening method using live torque/angle sensing.

FIGS. 19A and 19B show features of a tool according to an embodiment of the present invention.

FIG. 19C shows a partial sectional perspective view of a tool for use in an embodiment of the present invention.

FIG. 19D shows an exploded perspective view of a tool for use in an embodiment of the present invention.

FIGS. 19E and 19F show respective rotational positions of an inner nut engaging portion of an embodiment of the present invention. FIG. 19E shows the inner nut engagement portion in engagement with the inner nut member prior to release of the nut. FIG. 19F shows the nut in a release orientation.

FIGS. 20A and 20B show a tool according to an embodiment of the present invention applied to a segmented nut on a threaded male member.

FIGS. 21A, 21B and FIG. 22 show a tool according to an embodiment of the present invention applied to a segmented nut on a threaded male member.

FIGS. 23A and 23B show a thread/reaction portion grip feature according to a further embodiment of the present invention.

FIGS. 24A to 24F show features of a tool according to an embodiment of the present invention configured for close fir to an adjacent fastener.

FIGS. 25A to 25B show a powered tool according to another embodiment of the present invention.

FIGS. 25C and 25D show application of a side entry power tool consistent with the embodiment shown in FIGS. 25A and 25B.

FIGS. 26A to 26F show features of an arrangement according to a further embodiment of the present invention for selective engagement/disengagement of the second portion (for engaging the inner nut member) with the first portion (for engaging the sleeve/collar) or the third portion (for engaging an end part of the threaded male member).

FIGS. 27A to 27F show features of an alternative arrangement according to a further embodiment of the present invention for selective engagement/disengagement of the second portion (for engaging the inner nut member) with the first portion (for engaging the sleeve/collar) or the third portion (for engaging an end part of the threaded male member).

FIGS. 28A, 28B and 28C show alternative embodiments of the present invention, each with powered drive means and gearing/torque multiplier capability.

FIGS. 29A and 29B show perspective and side views of a female fastener (e.g. segmented nut) worn or damaged through use. An upper right portion of the fastener is abraded or cleaved away at an angle through the fastener, representing typical wear or damage.

FIG. 29C shows a tool arrangement according to an embodiment of the present invention applied to a worn or damaged female fastener (such as a segmented nut) for release/removal thereof.

FIGS. 30A and 30B show partial cutaway views of a tool including sockets for use in release of a segmented nut according to an embodiment of the present invention.

FIGS. 31A and 31B show top views of release of a nut using the tool of FIGS. 30A and 30B.

### DESCRIPTION OF PREFERRED EMBODIMENT(S)

In the following detailed description, reference is made to accompanying drawings which form a part of the detailed description. The illustrative embodiments described in the detailed description, depicted in the drawings and defined in the claims, are not intended to be limiting. Other embodiments may be utilised and other changes may be made without departing from the spirit or scope of the subject matter presented. It will be readily understood that the aspects/embodiments of the present disclosure, as generally described herein and illustrated in the drawings can be arranged, substituted, combined, separated and designed in a wide variety of different configurations, all of which are contemplated in this disclosure.

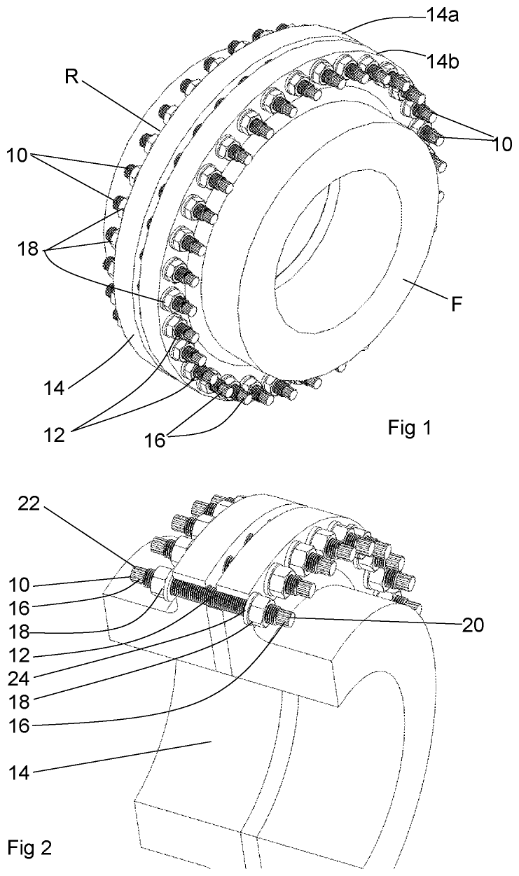

FIG. 1 shows a number of threaded male member s (aka stud-bolts or threaded rods) 12 according to an embodiment of the present invention applied to a flange joint 14 for the purposes of exemplifying the threaded male member in use. Associated piping, not shown, are connected to the flanges to provide a fluid flow conduit.

As shown, the flange joint includes two flanges 14a, 14b held in face to face contact by multiple threaded fastener arrangements 10 disposed around the flanges and each incorporating the threaded male member 12 and at least one nut 18, embodying the present invention.

Each threaded male member 12 has a reaction portion 16 at one end thereof. However, it will be appreciated that the reaction portion 16 can be provided at both (opposed) ends of the threaded male member 12, as shown by way of example in FIG. 2.

The fastening arrangement utilising the threaded male member 12 shown in FIG. 1 has two opposed plain (standard) nuts 18.

It will be appreciated that other nut types can be used, such as friction modifying nuts (e.g. having a nylon insert engaging with the thread of the stud) or segmented nuts. The relevant skilled person will therefore appreciate the advantageous adaptability of the threaded male member of the present invention for use with various nuts, and the resulting possibility to use a combination of such nuts in any one application.

The threaded male member 12 may include a said reaction portion at one end or at both ends.

The threaded male member 12 may include a frangible (shear) portion at one or both distal ends thereof. The frangible or shear portion configured to shear off at or above a threshold tightening torque. The threaded male member 12 may retain at least a portion of the reaction portion for release or re-tightening/tightness checking of the fastening arrangement.

As shown by way of example in FIG. 2, a said reaction portion 16 is provided at each of first 20 and second 22 respective opposed ends of the threaded male member 12 of the fastener arrangement 10.

A washer 24 can be provided between the nut and the workpiece e.g. the flange 14a, 14b.

It will be appreciated that the reaction portion 16 can be provided at or towards the respective end i.e. the reaction portion may extend to the very end of the threaded male member or may stop short of the very end.

As shown by way of example in FIG. 1, the reaction portion can be provided at the ‘front’ (F), being the facing side that the application/release tooling will be applied.

The rear/back nut at the rear face (R) (such as in FIG. 1) can preferably be held by a thread-lock (e.g. a curable thread lock fluid) to prevent the threaded male member rotating itself through the back nut and out of the front face during tightening of the front nut i.e. as a counter-torque is applied to the threaded male member via the reaction portion reacting the tightening torque applied to the front nut.

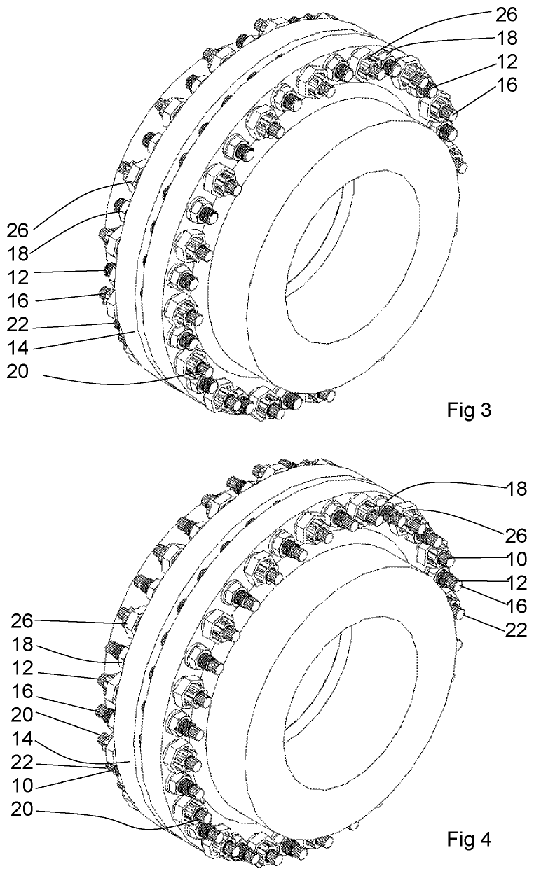

FIG. 3 shows an example of the threaded male member 12 applied to a flange joint 14 using alternating plain nuts 18 and segmented ‘lateral release’ nuts 26. The segmented nuts can be alternated with plain nuts on one or both faces (e.g. front and/or rear faces) of the flange joint. Such alternating around one or both faces of the flange 14 provides additional tool clearance between nuts 18, 26 where the segmented nuts 26 have a larger overall diameter than the plain nuts 18.

It will be appreciated that the example of the threaded male member 12 shown in FIG. 3 has the reaction portion 16 at one end 20, 22 thereof.

The rear nut 18 can have thread locker applied and fastener assembly is performed via the front using a segmented nut at end 20. This is advantageous in that the segmented nut at the front end does not have, or need to have, thread locker applied and therefore the segments of the segmented nut remain free to release laterally away from the threaded rod (i.e. without otherwise being retained by thread locker) upon release of the outer, retaining, sleeve.

It will be appreciated that the threaded male member can be used the opposite way around in one fastening system relative to another fastening system using the same type of threaded male member with just one end having the reaction portion. In the example shown in FIG. 3, the threaded rod is reversed alternately in adjacent fastening systems for the flanges. Such reversal also allows room for the segmented nut that is wider than the standard plain nut at the opposite end of an adjacent threaded male member, as shown.

As shown by way of further example in FIG. 4, the threaded male member 12 can include a respective reaction portion 16 at each end thereof, as discussed above in relation to FIG. 2. In this embodiment, neither the front or rear nut needs, or has, thread locker applied.

If one or more of the nuts, particularly plain nuts 18, becomes seized (e.g. due to corrosion and/or damage), a release tool can be applied to the reaction portion 16 or each reaction portion 16 and the respective nut 18, 26, for release of the fastening arrangement 10 incorporating the threaded male member 12.

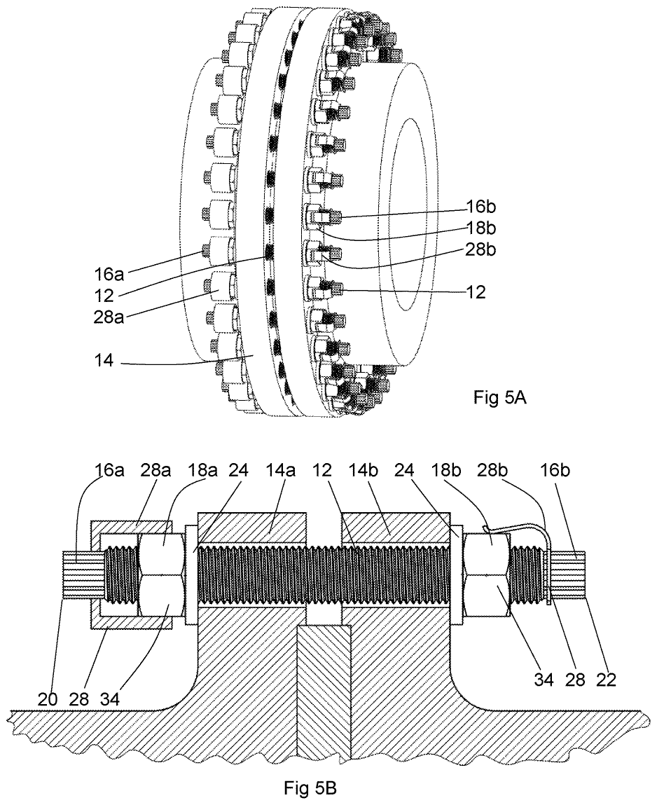

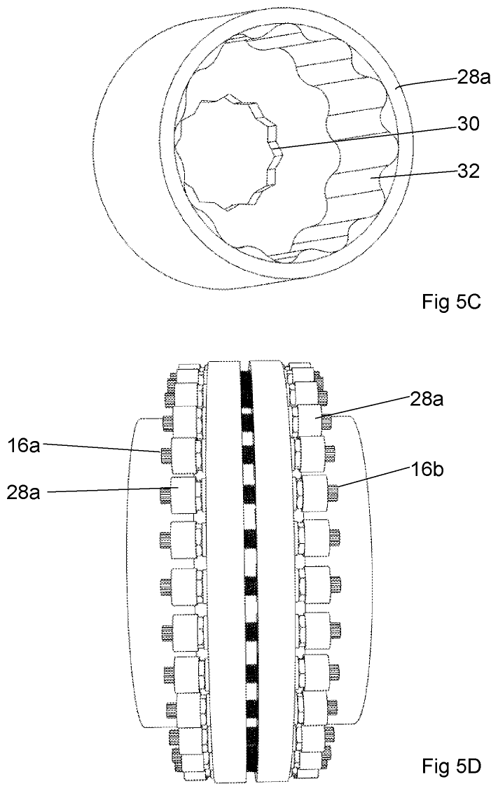

As shown by way of example in FIGS. 5A, 5B and 5C, a locking device 28 (e.g. 28a, 28b) can be provided to prevent relative rotation of the threaded male member 12 and respective nut 18.

The locking device 28, such as a locking cap 28a or resilient/spring device 28b, can be applied to the front and/or the rear/back nut 18 (18a, 18b) to prevent the threaded male member 12 rotating relative to the respective front and/or rear/back nut (18a, 18b).

In use, the locking cap 28a is placed over and is engaged with the reaction bit 16a and nut 18a so as to prevent relative rotation between the threaded male member 12 and the rear nut 18a. A tool (not shown), incorporating counter-rotating sockets, is then applied to tighten the front nut 18b using reaction portion 16b to provide the tightening counter-torque. Once the joint has reached its required tension setting, an anti-rotation spring device 28b may be placed over and engage with the reaction bit 16b and nut 18b. In one embodiment locking cap 28a may be left in-situ to provide a permanent anti-rotation function on the back nut 16. Alternatively, the locking cap 28a may be removed (and used on another joint) and replaced by a spring device 28b.

The locking device 28 can be applied at each of the opposed ends 20, 22 of the respective threaded male member 12, as shown by way of example in FIG. 5D.

Once the joint is assembled, the locking device 28 can preferably be left permanently of the threaded male member 12 and nut 18, and therefore provides an anti-rotation feature during use of the fastening arrangement 10.

Sufficient angular free-play between the reaction portion 16 and locking device 28 interface 30, and between the nut 18 and locking device 28 interface 32 can be provided to allow the locking device 28 to be installed irrespective of the angular relationship between the reaction portion 16 and the outer profile of the nut 18 (such as one or more faces 34 of a hexagonal nut).

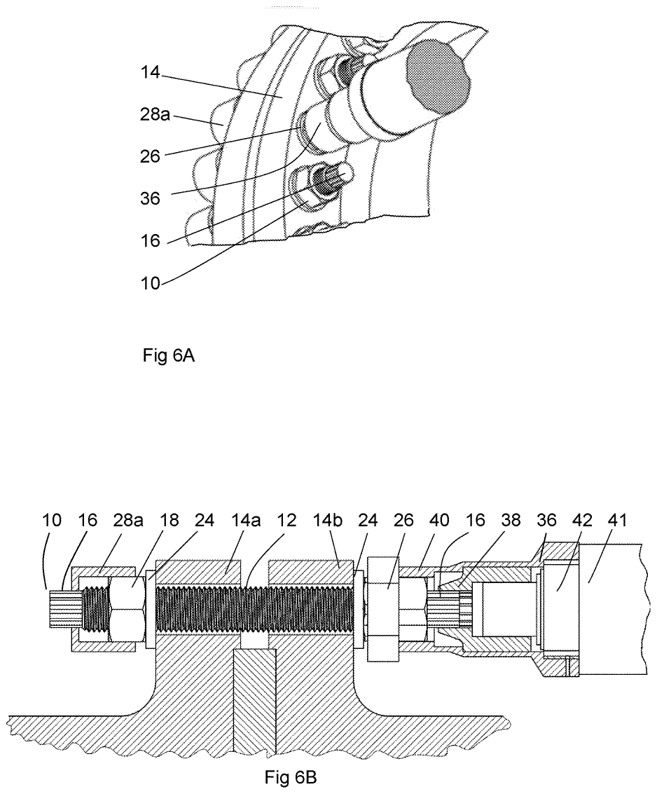

FIGS. 6A and 6B show, by way of example, a flange joint 14 including a fastening arrangement 10 using a threaded male member 12 with an anti-rotation or locking device 28 applied at one end and a torque socket arrangement 36 applied to a segmented nut 26 at the other end.

The torque socket arrangement includes a first socket 38 for engaging with the reaction portion 16 and a second socket 40 for engaging with the nut 26. The sockets are preferably concentric and preferably part of the same tool 36. The tool can include a drive portion 42 for engagement with drive from a power tool or manual tool or driver 41. Alternatively, the tool 36 can incorporate power drive of such a power tool or driver 41.

The sockets 38 and 40 are arranged concentrically/coaxially, with the inner (second) socket 40 and outer (first) socket arranged for relative rotation with respect to each other, such as the sockets counter-rotating or one rotating and the other stationary for application or removal of the nut 18 relative to the threaded male member 12.

The torque socket arrangement (tool) 36 may include a socket arrangement for engagement with an inner nut and/or outer sleeve of a segmented nut.

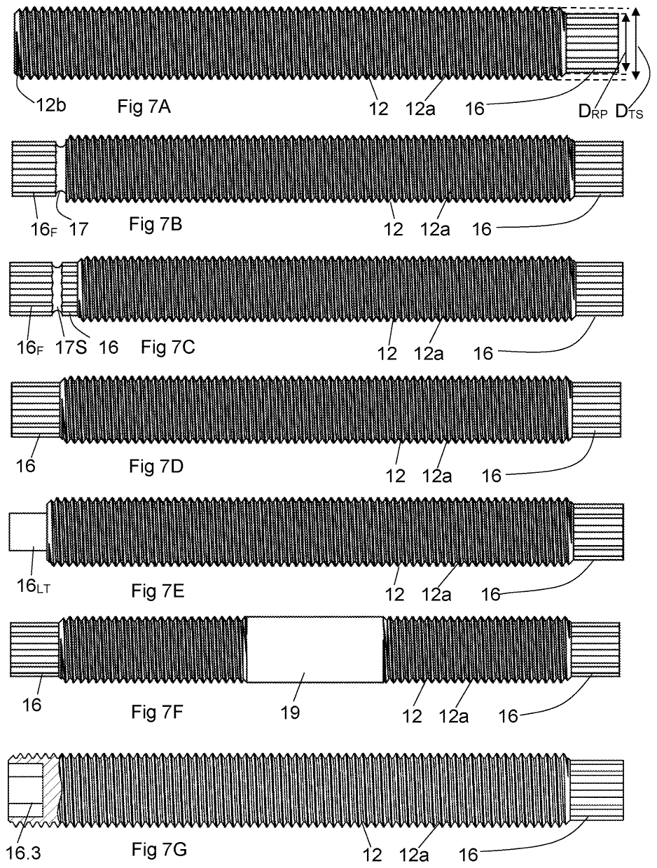

Embodiments of the threaded male member 12 are shown by way of example in FIGS. 7A to 7G.

FIG. 7A shows an embodiment of the threaded male member 12 having a reaction portion 16 at one end, a single handedness thread 12a and a plain end 12b (e.g. no reaction portion or frangible portion).

FIG. 7B shows a threaded male member 12 with single handedness thread 12a and a reaction portion 16 at one end, and a frangible reaction portion 16_{F} at the other end, the frangible reaction portion 16_{F} connected to the rest of the threaded male member by a fail region 17, such as a frangible (shear) section 17S. The frangible reaction portion 16_{F} can be used for installation of the fastening arrangement (e.g. clamping pipe flanges together) wherein the frangible reaction portion shears off when the fastening arrangement is sufficiently tightened. For removal/release, the permanent/integral reaction portion 16 at the other end can be used. The permanent/integral portion 16 may be further designed such that a shearing failure occurs if the required fastening torque has been exceeded and indicates a failure of the fastening system that requires remediation by the operator (e.g. a change to a new nut and bolt). For this purpose, the permanent/integral portion 16 may further include a frangible shear section specifically designed for this purpose (not shown).

FIG. 7C shows a similar threaded male member 12 as in FIG. 7B; however, a permanent reaction portion 16 is provided between the frangible reaction portion 16_{F} and the thread 12a. When the frangible reaction portion is removed during installation, the permanent reaction portion remains and can be used for release/removal of the fastener. It will be appreciated, of course, that a nut will be provided on the thread adjacent the permanent reaction portion. An anti-rotation cap/resilient spring is applied to the remaining permanent reaction portion upon completion of the installation process.

FIG. 7D shows an alternative embodiment of the threaded male member 12 with a permanent reaction portion (full torque capacity/capability) 16 at each of the two opposed ends.

FIG. 7E shows a permanent full torque reaction portion 16 at one end and a low/reduced torque capability/capacity reaction portion 16_{LT} at the other end. The low toque reaction portion 16_{LT} can be, for example, a square drive (external and/or internal/hollow drive), of lesser diameter/width than the full torque capability/capacity 16. The low torque reaction portion 16_{LT} may be used to accept an appropriate reaction cap/resilient spring during the installation/removal procedure whilst the permanent (full torque) reaction portion is used to apply the full installation/removal torques.

FIG. 7F shows an example of the threaded male member 12 having a plain shank portion 19. It will be appreciated that any embodiments of the threaded male member of the present invention may have one or more non-threaded/plain shank portion(s) intermediate the ends of the threaded male member/reaction portion(s).

Preferably, for maximizing the torque capability of the reaction portion, the outer diameter D_{RP} (see FIG. 7A for example) of the reaction portion 16 is less than the outer diameter D_{TS} of the thread 12a of the threaded male member 12.

FIG. 7G shows an alternative embodiment of the threaded male member 12 with a permanent reaction feature (full torque capacity/capability) at both ends, using the internal reaction portion 16.3 at one end (preferably as an internal primary reaction portion) and the external reaction portion 16 at the other end. The internal reaction portion at one end may be used to accept an appropriate reaction cap/resilient spring during the installation/removal.

The handedness of the thread is the same in each outer threaded portion where the respective nuts 18 will be threaded on the threaded male member and tightened.

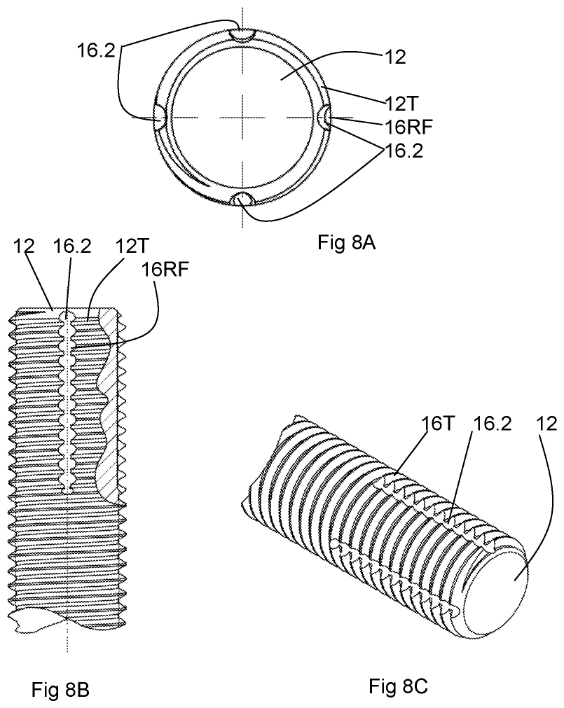

As shown by way of example in FIGS. 8A to 8C, an external reaction portion 16 can include external longitudinal slots/flutes 16.2 in the (male) threaded male member 12 and the thread 12T of the threaded male member is continuous or its continuity is interrupted by the slots/flutes along the reaction portion. The slots/flutes 16.2 can be partial or along the full length of the threaded male member 12 (whether a bolt, stud or threaded bar, and whether or not threaded all the way along the shaft or having one or more plain shank portions or other features). The slots/flutes 16.2 may be continuous along their respective length or discontinuous. Alternatively, one or more of the slots/flutes 16.2 can be continuous and one or more other slots/flutes discontinuous. The slots/flutes may be formed/machined into the thread 12T or the thread may be formed/machined across the slots/flutes 16.2.

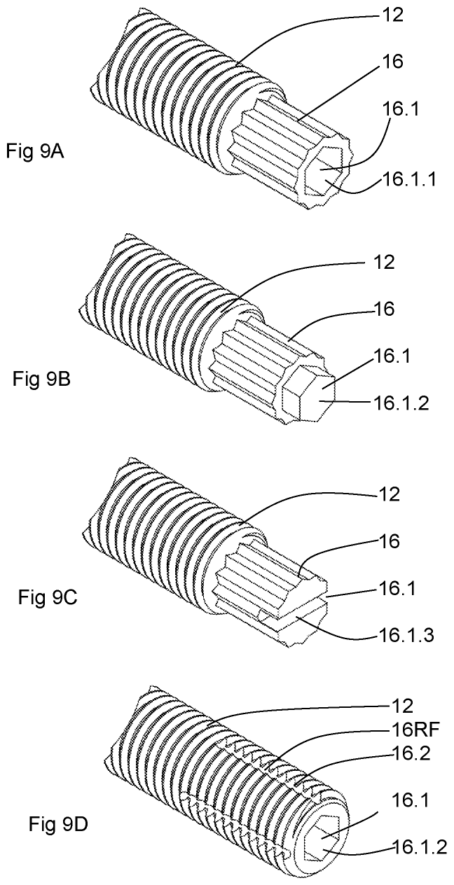

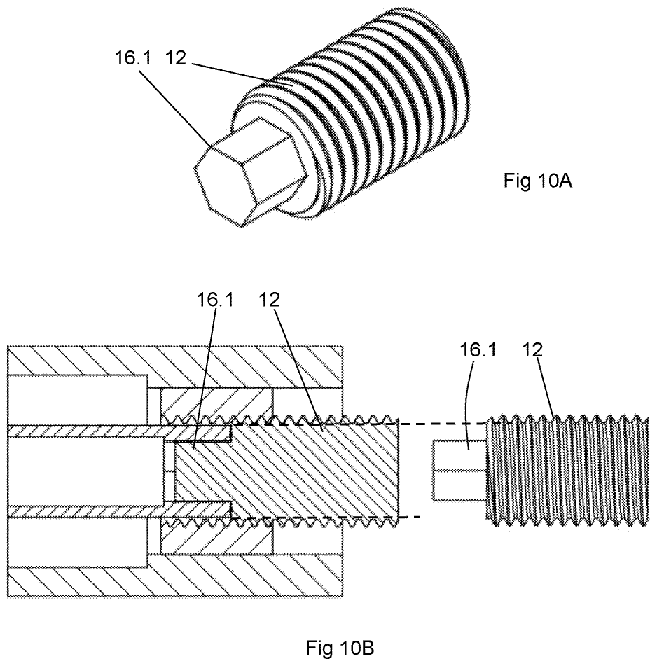

FIGS. 9A to 9C show alternative embodiments of a reaction portion 16 of a threaded male member 12. The threaded male member includes the reaction portion as a primary reaction portion e.g. capable of transmitting full load torque, and a secondary reaction portion 16.1. The secondary reaction portion can include a cavity or recess 16.1.1 (which may be of polygonal cross-section and may be straight sided or tapered into the end of the threaded male member). It will be appreciated that reference to the threaded male member means that somewhere along the length of the shaft there is an external thread for receiving a nut type fastener, and the thread need not extend to the distal end of the shaft. FIG. 9B shows an example of an embodiment having a projecting secondary reaction portion 16.1 as a polygonal projection 16.1.2. FIG. 9C shows an alternative embodiment having a secondary reaction portion 16.1 as a slot or channel 16.1.3 across and into the distal end of the threaded male member. It will be appreciated that a combination of projection and cavity/slot may be provided.

A combination of a reaction portion 16 having an external reaction feature 16RF, such as external flutes/slots 16.2, and an internal or external secondary reaction feature 16.1 can be provided.

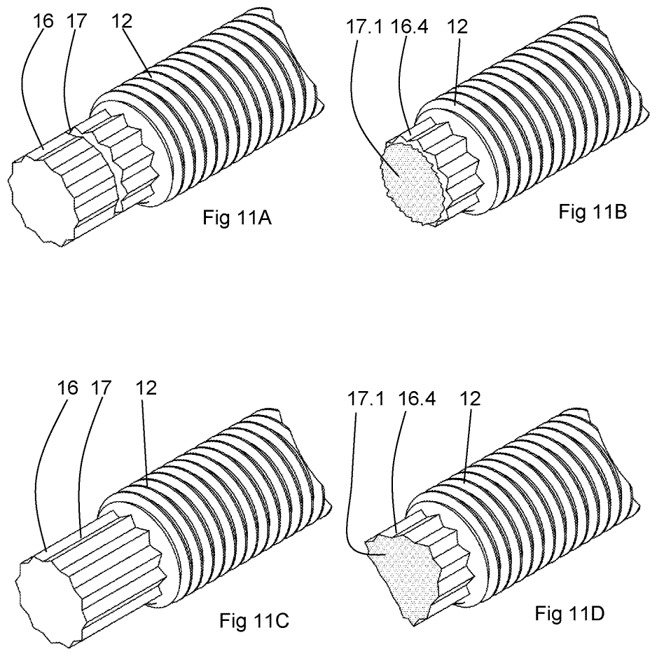

As shown by way of example in FIGS. 10A and 10B, the reaction portion can be sized so that a socket can access the reaction portion through a nut i.e. the outside diameter (OD) of the socket can be within the inside diameter (ID) of the nut. This can help with running the nut down as the inner socket can access the reaction before the nut clears the portion (an internal reaction portion effectively achieves the same.

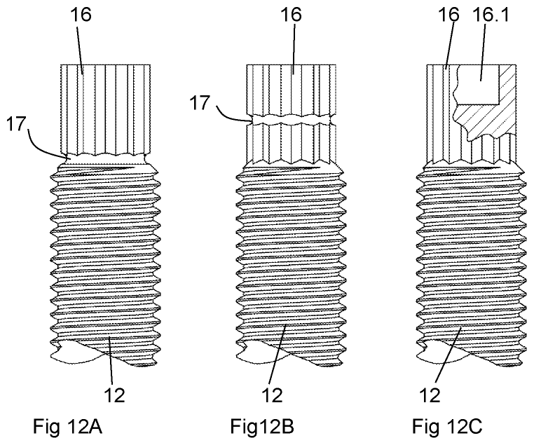

The reaction portion 16 can include a fail region 17 (e.g. 17S), such as to indicate a failed tightening/bolting process when the torque applied exceeds the limit sustainable by the fastening arrangement. By way of example, FIG. 11A shows an external reaction portion 16 and a groove into the material of the reaction portion providing a fail region 17. FIG. 11B shows an example of the ‘designed-in’ fail region failed whereby an end of the reaction portion has sheared off due to the applied torque exceeding the torque sustainable before failure, indicating a failed tightening (overtightening) process. The exposed sheared end 17.1 is shown in FIG. 11B. The fail region 17 providing such a facture point that can also be used to secure a retainer 119 e.g. a clip, such as a circlip, for an anti-rotation device (e.g. a locking device) 28 or rotation indicator device. The residual portion 16.4 of the reaction portion 16 after failure can be used to connect a tool to aid removal of a nut type fastener after. As shown by way of example in FIGS. 11C and 11D, the fail region 17 can be inherent in the material of the reaction portion, such as a weakened zone, choice of material, different hardening to other regions etc. The failure mode can rely on a choice of dimensions and material characteristics to ensure a reaction portion 16 failure indicates a tightening/bolting process failure.

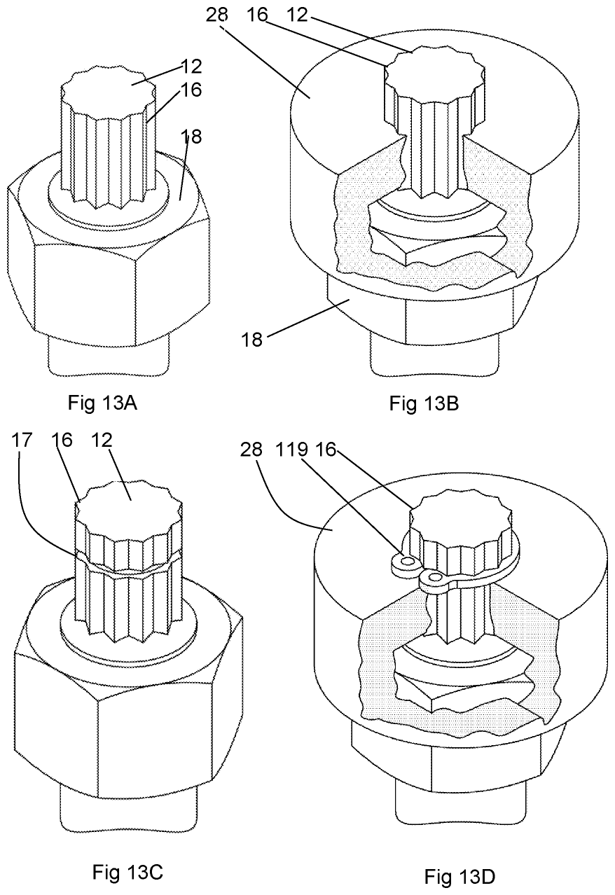

FIGS. 12A-12C show examples of fail regions structured into the reaction portion 16, such as a fail region between the base of the reaction portion and the start of the thread (FIG. 12A), a fail region groove in the external surface of the reaction portion (FIG. 12B) and an internal recess weakening the end of the reaction portion (FIG. 12C).

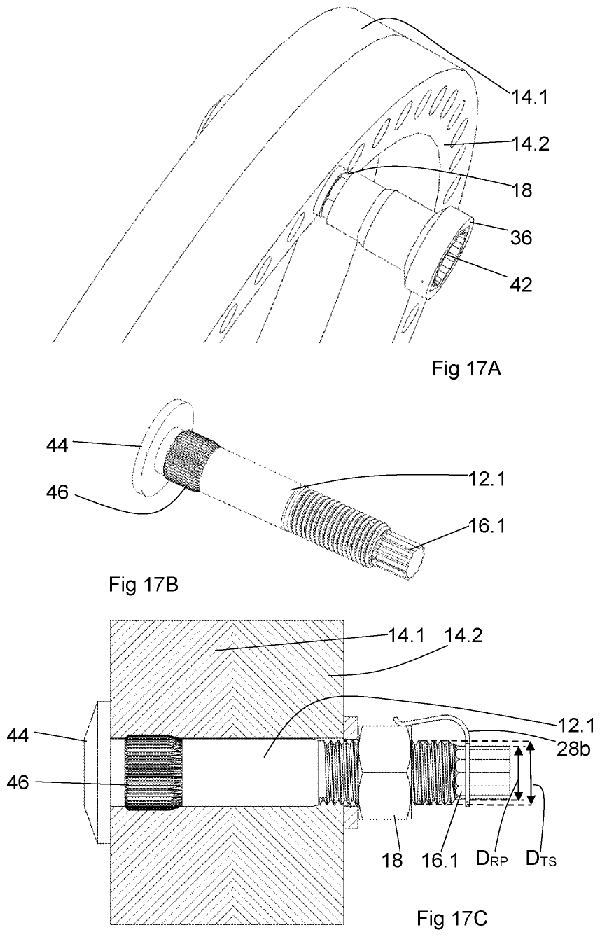

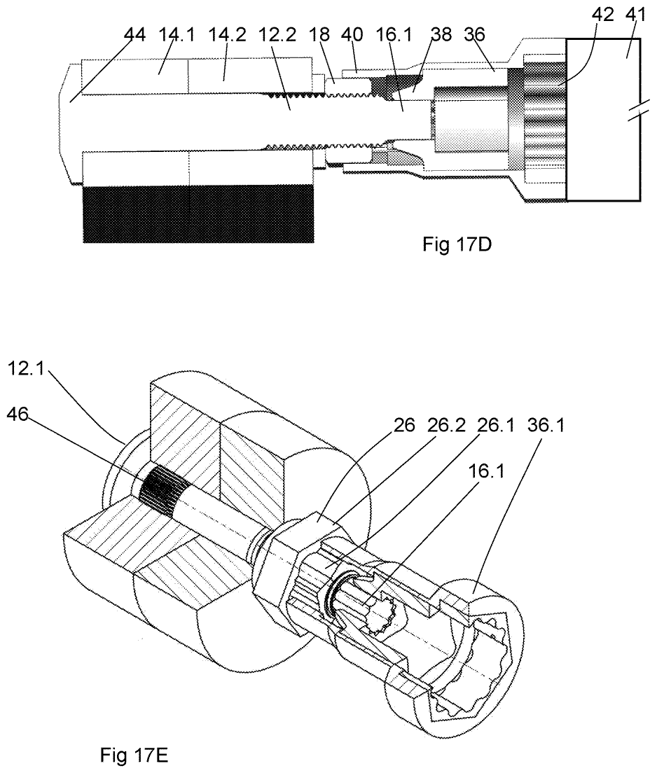

One or more embodiments of the present invention is applicable to a fixed threaded male member 12.1, 12.2 arrangement as shown in FIGS. 17A to 17E.

For example, as shown in FIGS. 17A, 17D and 17E, a fixed threaded male member 12.1, such as a wheel stud for mounting a wheel rim 14.2 to a wheel hub 14.1 of a vehicle, can be tightened by a torque socket arrangement 36, 36.1 (power tool not shown).

As shown in FIG. 17D by way of example, a section of a wheel rim 14.2 is shown being tightened onto a wheel hub 14.1 with the retained threaded male member 12.2 having an integral reaction portion 16.1.

Unlike the embodiment shown in FIG. 17C, the threaded male member 12.2 does not include a spline engaging with the hub 14.1. The threaded male member 12.2 can be a friction/interference or other tight fit or can be a loose/looser fit whereby, if the nut 18 is rotated for release from a tightened configuration on the threaded male member, the threaded male member would otherwise tend to rotate with the nut, thereby preventing proper release and removal of the nut (particularly a plain nut). Whereas, with the reaction portion 16.1 integral to the threaded male member 12.2, the nut can be released by application of a release torque to the nut and a counter-acting torque to the reaction portion.

As shown in FIG. 17E, the nut threaded on the threaded male member 12.1, 12.2 can be a segmented ‘lateral release’ type nut 26, such as having an inner nut 26.1 formed of multiple segments and an outer retaining and release sleeve or collar 26.2.

An anti-rotation device 28 can engage with the reaction portion 16 and the nut 18, 26 to restrict or prevent rotation of the nut relative to the threaded male member 12.

The anti-rotation device 28, such as a cap or resilient spring may be placed on the threaded male member 12.1, 12.2 and nut 18, 26 after tensioning has been completed to prevent the nut rotating relative to the threaded male member. See, for example, 28b in FIG. 17C.

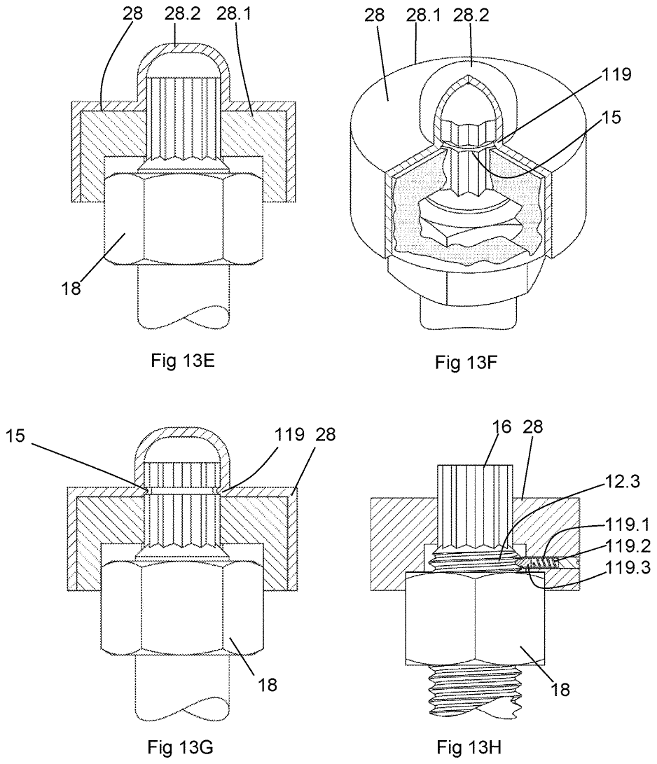

Variations of the anti-rotation device 28 can provide a passive device, such as a cap shown in FIGS. 13A and 13B e.g. no biasing to the nut and threaded male member.

The anti-rotation device 28 can have some free-play (e.g. up to 30 degrees for 12-point spline and hex nut) which is acceptable in some jointed applications (e.g. where only snug fit is required).

The anti-rotation device 28 may be retained on the threaded male member e.g. at the reaction portion 16 by a retainer 119, such as a releasable retainer (e.g. a circlip). The retainer 119 can be retained in a groove 15 in an end region of the threaded male member 12, which may also be a fail region 17 groove of the reaction portion 16, as shown by way of example in FIGS. 13C and 13D. Retention of the anti-rotation device can be by way of engagement of an internal portion thereof into the groove 15/17, such as a moulded projection or integral resilient means.

An anti-rotation device provided as an enclosed cap 28—provides dust protection and could be pre-filled with grease etc., to reduce corrosion/seizure.

As shown in FIG. 13H, a retainer 119.1 can engage with a thread portion 12.3 of the threaded male member 12, thereby gripping the thread portion and prevent axial removal of the cap 28 until the retainer 119.1 is released. The retainer 119/119.1 can include a screw member, such as a grub screw or retainer member 119.3 biased into engagement with the thread portion 12.3 by a resilient member 119.2

The anti-rotation device 28 can include biasing to bias the fastening system in a tightening direction. For example, a first portion 28.3 of the anti-rotation device may be biased to rotate relative to a second portion 28.4 thereof. Biasing can be by way of resilient biasing means 29 (such as one or more springs or resilient members). The resilient biasing means may act between a first stop 31.1 on one of the portions 28.3, 28.4 and a second stop 31.2 on the other of the portions 28.4, 28.3. The resilient biasing means can be disposed in respective channels 33. Rotation of one portion relative to the other can provide a visual via by the extent of the resilient biasing means or other visual indication through the respective slot, such as a colour indication.

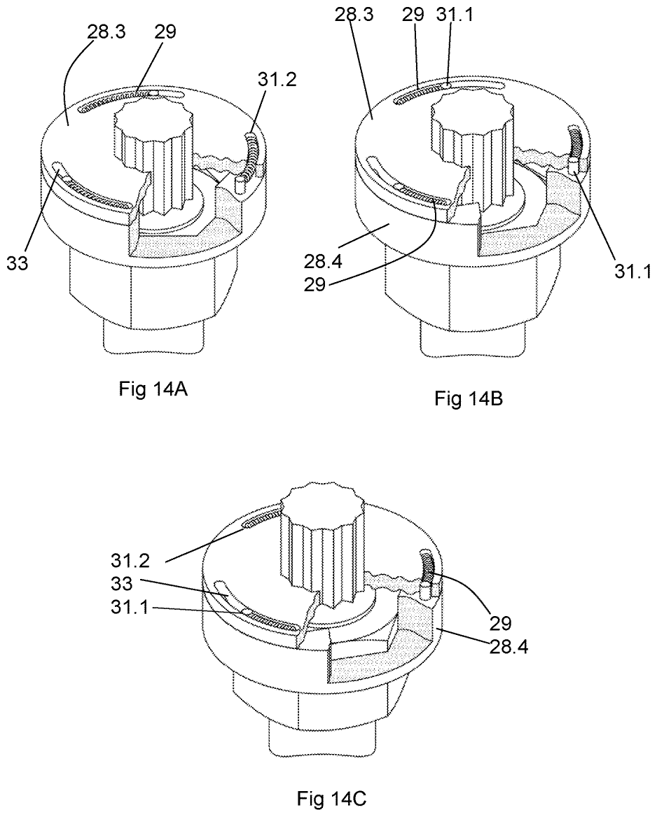

In FIG. 14A, the first portion 28.3 is engaged with reaction portion 16. The second portion 28.4 does not yet reach the nut. At the step shown in FIG. 14B, an operator twists the second portion relative to the first portion (e.g. against the circumferentially acting springs) in the nut “unwinding” direction before engaging the second portion with the nut (e.g. on outer surfaces of the hexagonal nut) thus creating a residual biasing torque in the nut tightening direction. FIG. 14C shows a final state wherein the second portion is engaged with the nut and the circumferential springs are left in a compressed state to maintain a biasing torque in the nut tightening direction.

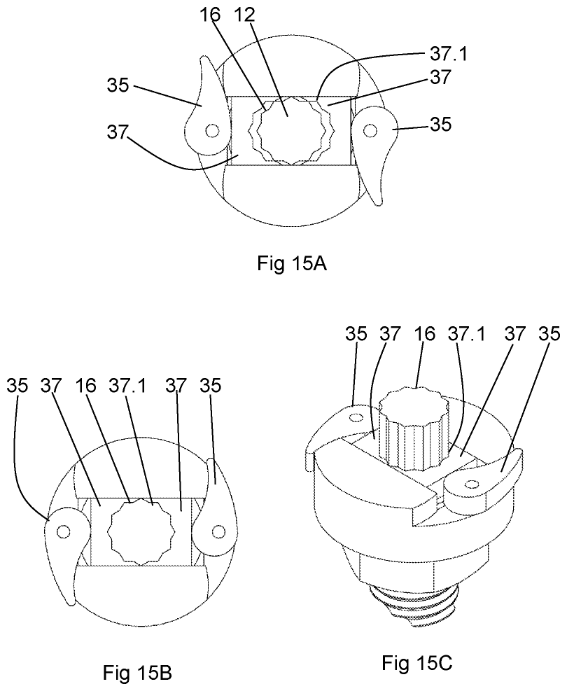

The anti-rotation device 28 can have an alternative locking device configuration, as shown by way of example in FIGS. 15A to 15C. Sliding elements 37 can engage with reaction portion 16 (e.g. spline of a bolt). The sliding elements are held in by over-centre cams 35. Once tightening of the fastener arrangement is complete, any residual torque within the anti-rotation (locking device) 28 can be relieved by unlocking the cams 35 to allow the sliding elements to move out radially. FIG. 15A shows the cams unlocked and the anti-rotation device in a released state. The sliding elements can have an engagement surface complementary to the spline of the reaction portion or can be resilient to resiliently deform on engagement. FIGS. 15B and 15C show the cams 35 rotated to a locked position and the sliding elements 37 engaged with the spline.

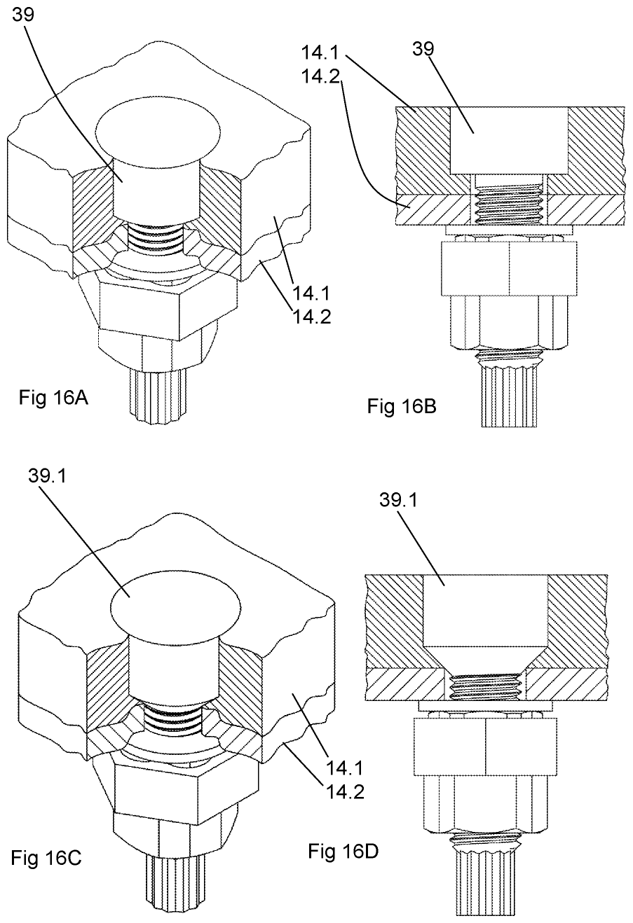

FIGS. 16A and 16B show examples of a fastener arrangement for fastening a wear plate 14.1 to a support 14.2. The fastener arrangement includes a bolt 39 with a cylindrical bolt head and plain seat. FIGS. 16C and 16D show examples of a fastener arrangement with a bolt 39 with a tapered bolt seat. It will be appreciated that the bolt requires no key or special shape to prevent rotation within the wear plate or support. Torque and counter-torque during tightening is provided by the nut and reaction portion. This reduces the cost of the counter-sunk hole in the wear plate/liner (does not need to be an elongated bolt hole as is otherwise typical) also allows a significant part of the bolt head to wear without any loss of tension as bearing surface is deep in counter bore of wear plate.

The installation (tightening) phase can include the tool 36 engaging with the inner nut 26.1 of the segmented nut 26 and with the reaction portion 16.1.

For removal, the segmented nut can be removed with the same socket arrangement tool 36.1 used in the reverse torque applying rotation direction. Alternatively, a removal socket (not shown) can be applied to both the segmented nut inner nut 26.1 and the segmented nut outer sleeve 26.1 to “release” the outer sleeve and allow the inner nut segments to radially separate (e.g. if the nut has otherwise become seized for relative rotation of the entire nut relative to the threaded male member).

An outer diameter D_{RP} of the reaction portion 16 can be almost the same as, but slightly less than the outer diameter D_{TS} of the thread of the threaded male member 12. For example, as shown in FIG. 8C.

The anti-rotation device may engage, in use, with a reaction portion of the threaded male member and with the nut to prevent or restrict relative rotation of the nut and the reaction portion. The anti-rotation device may include a cap which, in use, at least partially covers the nut. The anti-rotation device may include resilient biasing means arranged and configured to, in use, engage with the reaction portion and a nut. The resilient biasing means may include a spring clip.

A method of preventing or restricting relative rotation of a nut on a threaded male member of a threaded male member fastener arrangement can include having an anti-rotation means engaged with the nut and with a torque reaction portion of the threaded male member. The anti-rotation means may include a cap or a resilient device applied to engage with the nut and with the reaction portion. The anti-rotation means may engage on the reaction portion and engages with at least one face of the respective nut.

A method of fastening or releasing a threaded male member fastening arrangement having a threaded male member and at least one nut may include applying a torque to the respective nut and applying a counter-torque to a reaction portion at a first end of the threaded male member.

The threaded male member can have a nut threaded thereon at a second end of the threaded male member, and the torque and the counter-torque is applied at the first end of the threaded male member.

The reaction portion can remain as part of the threaded male member after required application of the torque to tighten the respective nut(s) to a required tightening torque. For release of a tightened said nut, the method may include applying a release torque to the nut and a counter-torque to the reaction portion. For release of a tightened said nut, the method may include engaging a tool with the reaction portion, with an inner nut of a segmented nut and with an outer collar/sleeve of the segmented nut, and applying a torque to the inner nut and the sleeve/collar or to the reaction portion and the sleeve/collar, or with the reaction portion, inner nut and sleeve/collar, for release of the nut.

One or more embodiments of the present invention provides a tool arrangement wherein, when installing a female fastener (such as a nut), installation counter-torque is reacted directly to a male threaded fastener (such as a bolt). When releasing or removing the female fastener, release/removal counter-torque is preferably reacted directly by a part of the female fastener that can move in the opposite direction to another part of the female fastener. The female fastener can be a segmented nut having an inner nut member and an outer sleeve or collar.

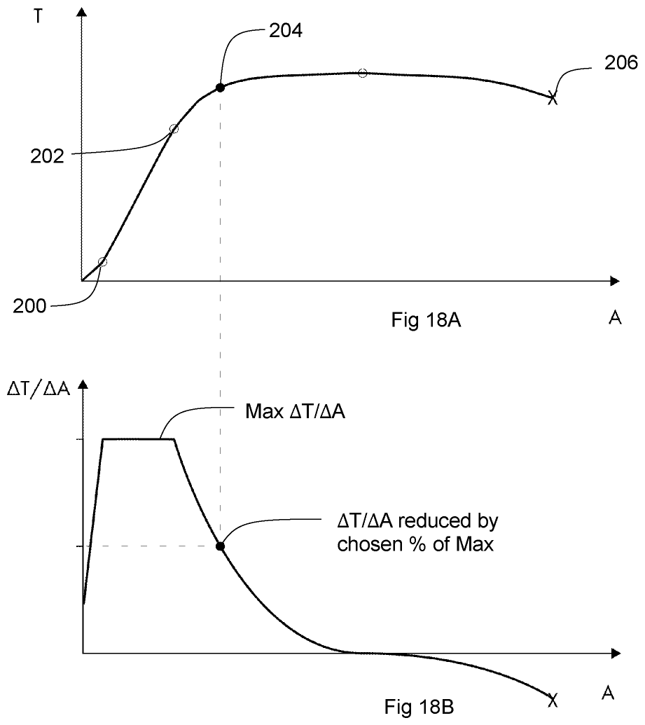

FIGS. 18A and 18B show graphs showing a control arrangement/system that uses torque and angle inputs (e.g. from a tool) to determine when to stop the fastening process. In particular, FIG. 18A shows change of torque T against change of angle A. The curve shows the plies of material to be fastened pulled into firm contact with one another (‘snug’ fit) 200. Elastic/plastic strain transition can occur 202, representing the minimum tension point for a ‘fully tensioned’ structural bolt manufactured to the minimum proof load requirements. Tightening is stopped 204, being the preferred tightening torque for the respective joint/fastening. Continued torque applied to the fastener arrangement see bolt/shaft failure 206.

According to embodiments of the present invention, tightening torque applied to the fastener arrangement is stopped when the change in applied torque reduces by a chosen threshold value relative to change in angle. For example, a reduction of 50% ΔT relative to ΔA indicates that the fastener arrangement is at the required torque. The percentage chosen for a given tooling control/sensing capability can be determined, such as by empirical iterations or test applications. For example, as the signal—noise ratio is improved, the set percentage can be reduced. A reduction can be beneficial as it minimises the amount of overshoot and resulting plastic deformation in the bolt. Notably, there is no need to pre-select the required angle-of-turn, and in the particular example, it is not required to perform a “snug” fit condition before completing the tightening of the fastener arrangement.

One or more forms of the present invention provides a tool arrangement for engagement with a fastener assembly having inter-engageable male and female fasteners, wherein the female fastener includes at least two parts configured to move relative to one another for release of the female fastener; wherein, for at least part of installation of the female fastener on the male fastener, the tool arrangement engages with and provides a torque to the female fastener and the tool arrangement engages with and reacts a counter-torque through the male fastener; and wherein, for release of the female fastener from the male fastener, the tool arrangement engages with and reacts counter-torque through a said part of the female fastener which moves relative to at least one other said part of the female fastener.

It will be appreciated that the installation counter-torque can be reacted directly through the male fastener (which male fastener preferably has a threaded male member, such as a threaded bolt, threaded male member or threaded rod). The removal counter-torque is reacted directly to a part of the female fastener which can move in the opposite direction to another part of the female fastener.

Concentric sockets (such as embodied in the respective second and third portions) can include two said sockets controlled by a torque relief mechanism and/or control means to move rotationally angularly relative to one another to relieve counter-torques developed by the tool arrangement when installing or tightening the female and male fasteners.

The tool arrangement can include at least one sensor to detect torque/counter-torque. The tool arrangement can be provided to reduce the counter torque to substantially zero torque for release of the tool arrangement from the fastener assembly. Counter torque relief can be by relative rotation of the second and third portions (e.g. sockets) by 5° or less, preferably 2° or less, more preferably by 1° or less.

The female fastener can include a nut having a sleeve or collar retaining together segments of an inner nut member when the nut is assembled for installation and allowing relative movement of the segments when released by the sleeve or collar.

One or more exemplary embodiments of the present invention provides a tool arrangement 120 includes at least three concentric engagement portions (such as first portion 122, second portion 124 and third portion 26).

The at least three engagement portions may respectively engage with portions of a female fastener (such as the first portion to engage with a sleeve/collar 116 of a female fastener 114, and a second portion to engage with an inner nut member 118) and part of a male fastener (such as an end of a threaded male member—which end can, in at least one preferred embodiment, itself have a thread and can be shaped/configured to receive engagement and torque from the third portion and optionally a fourth portion/engagement means).

The tool arrangement can have at least three coaxial sockets, which may be or include the first, second and third portions). For example, at least three concentric sockets as part of a single tool (e.g. integrated into the same tool). In at least one preferred embodiment, the at least three sockets are driven by selection from at least two drives. Drive from at least one of the drives to the respective socket is preferably user selectable. The tool arrangement can include a first socket drive arranged and configured to drive the first socket, a second socket drive arranged and configured to drive the second socket, and a drive to said third socket is selectable or not engaged to drive said third socket at all or until selected. The tool arrangement can include a said second socket drive arranged and configured to drive said second socket, and a said third socket drive arranged and configured to drive said third socket, and said first socket drive to said first socket is selectable or not engaged to drive said first socket at all or until selected. Preferably the tool arrangement includes selection control to select driving the first and second sockets or driving the second and third sockets. Drive to the first and second sockets can be in concert such that the first and second sockets rotate together.

One or more embodiments of the present invention provides a tool arrangement or system (e.g. including at least one tool) having first reaction means to release a fastener of a fastener assembly, and second reaction means to install the fastener of the fastener assembly.

The first reaction means can have sleeve/collar and inner nut member engagement portions arranged and configured to respectively engage with a sleeve/collar and inner nut member of a segmented nut and provide counter directional torques for rotation of one of the portions relative to another of the portions to release of the nut. The second reaction means can have nut and threaded male member engaging portions arranged and configured to respectively engage with an inner nut member of a segmented nut and the threaded male member onto which the nut is threaded and provides counter directional torques to the inner nut member and the threaded male member to threadingly advance or reverse the segmented nut along the threaded male member. The first and the second reaction means can be separate tools from each other, or the first reaction means and the second reaction means are provided in a single tool. The first reaction means and the second reaction means can be selectively engageable allowing selection of one or the other of the first and second reaction means. The first reaction means and the second reaction means can be axially aligned with each other.

One or more embodiments can provide at least one tool for use in releasing a segmented nut from a threaded male member, the segmented nut including multiple inner segments and an outer sleeve, the at least one said tool including: a first portion configured to engage with the sleeve, a second portion configured to engage with at least one segment of the inner nut member, and a third portion to engage with a reaction portion of the threaded male member.

For releasing the segmented nut, the respective tool can have selective engagement of the first portion with the sleeve and the second portion with the at least one segment, for relative rotation of the sleeve and the inner nut member. For tightening the segmented nut, the respective tool can have selective engagement of the second portion with the at least one segment and the third portion with the reaction portion of the threaded male member, allowing relative rotation of the segmented nut and the threaded male member.

One or more of the first portion, the second portion and the third portion can be arranged and configured to move rotationally and/or longitudinally with respect to one to at least one other of the first portion, second portion and third portion relative to a central axis of the respective tool.

The respective tool can provide relative sliding motion of the first reaction means relative to the second reaction means, or the first portion with respect to the second portion and/or the second portion relative to the third portion. Such relative movement may be powered e.g. electrically, pneumatically and/or hydraulically.

At least one of the first, second and third portions can be rotationally and/or longitudinally/axially moveable, and may be powered electrically, pneumatically or hydraulically powered.

A selection mechanism can be provided to selectively move one or more of the first, second and third portions for selective respective engagement of the respective tool with the fastener and/or the reaction portion of the threaded male member.

At least one clamp arrangement can be arranged and configured to clampingly engage with at least one of a sleeve/collar, inner nut member segment(s) and/or reaction portion of the threaded male member.

Grip means can be provided to, in use, grip an end portion of the threaded male member. The grip means can include multiple engagers that together grip the end portion of the threaded male member.

The second reaction means and/or third portion may include end engagement means (such as a fourth portion) to engage with an end portion of the threaded male member.

Alternative to, or in addition to, utilising a fourth portion, the tool arrangement can be configured such that the second engagement portion to engage with the inner nut portion and the reaction torque being transferred back to the operator at least until the third engagement portion can engage with the reaction bit of the bolt—this allows a relatively low torque to be applied to get the nut down far enough on the threaded male member to allow access of the third engagement means with an end portion of the threaded male member.

The tool arrangement and/or second reaction means can include a lock means that locks the third engagement portion to the tool body so as to transfer that torque to the operator.

The second reaction means can include biasing means to bias the end engagement means for biased engagement and/or disengagement with the end portion. The biasing means may include resilient means.

A torque limit mechanism can be provided to limit torque applied by the end engagement means.

Preferably, the reaction portion of the threaded male member includes an external portion of the threaded male member, an internal portion of the threaded male member or a combination of such external and internal portions.

A fastener system can include a segmented nut, a threaded male member (such as a bolt) and a tool arrangement according to one or more forms of the present invention.

The reaction portion of the threaded male member preferably includes an internal cavity or socket portion for receiving part of the tool and/or the reaction portion includes an external head. The inner nut member can provide reinforcement support to the internal cavity/socket portion of the threaded male member where that internal cavity portion of the threaded male member is adjacent the inner nut member when the segmented nut is threaded onto the shaft. The internal cavity/socket portion is preferably at least partially within the inner nut member when the fastener assembly is fastened. The cavity/socket portion may extend no deeper into the threaded male member than an upper extent of the outer sleeve away from the bearing face of the segmented nut.

The reaction portion may be connected to the threaded portion by a weak zone such that the reaction portion shears off the threaded portion upon application of sufficient torque causing intentional failure at the weak zone.

At least 3 thread pitches, preferably 5 or more, of the threaded male member can be provided above a bearing face of the female fastener (segmented nut) with respect to the work piece e.g. within the segmented nut to ensure tightening/structural integrity of the fastener assembly. At least 3 thread pitches, preferably 5 or more, of the threaded male member can extend beyond the female fastener e.g. above the segmented nut to provide a minimum thread grip region at the distal/free end of the threaded male member. The first reaction means and/or first portion may include at least one clearance region that allows the tool to fit over end engage with a nut that is relatively close to another nut in situ or other fixed feature. The at least one clearance region includes an opening and/or a recess.

A thread engager can be provided to engage with the thread of the threaded male member. Preferably the thread engager is provided as part of, or working in association with, the second reaction means and/or the third portion. The thread engager preferably includes at least one thread engagement portion that distorts, deforms or damages the thread of the threaded male member.

A mechanism may be provided that moves the at least one engagement portion inwards by a cam arrangement or inclined plane, cone, thread, or combination of any two or more thereof. Preferably the at least one engagement portion increases inwardly directed force on the thread as the second reaction means tries to rotate relative to the reaction portion of the threaded male member in response to the torque applied to the inner nut member.

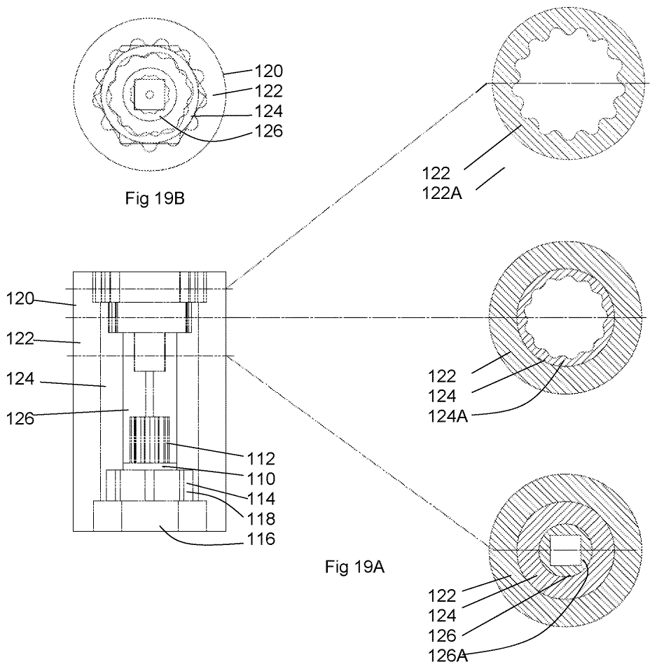

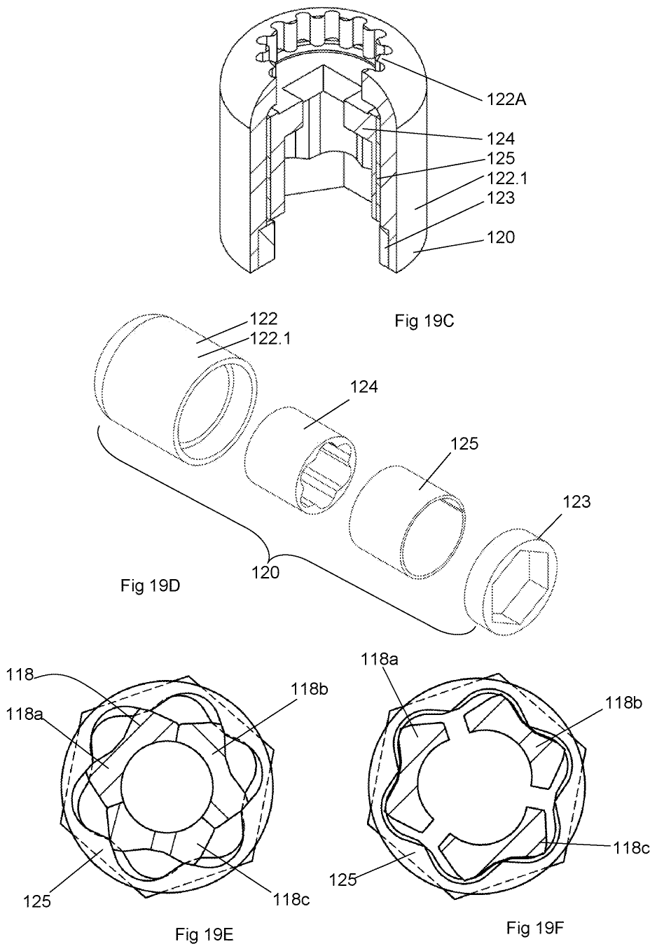

One or more embodiments of the present invention can include selective engagement between the first and second portions and/or between the second and third portions. By way of non-limiting example, FIG. 19A shows a threaded male member 110, such as a bolt, with a segmented nut type fastener 114 wound thereon. The segmented nut includes multiple segments 118 retained together by a sleeve or collar 116. The shaft has a reaction portion 112 configured to receive a portion of a tool 120. The tool 20 is also configured to engage with at least one of the sleeve/collar 116, the inner nut member 18 or the reaction portion 112.

In the embodiment shown, the tool 120 has a first engagement portion 122 arranged and configured to engage with the sleeve/collar 116, a second engagement portion 124 arranged and configured to engage with the inner nut member 118 and a third portion arranged and configured to engage with the reaction portion 112. In use, for example, the first portion 122 and the second portion 24 engage with the segmented nut for release of the segmented nut. The tool 120 provides relative rotation of the first portion 122 and the second portion 124 so that the sleeve/collar 16 and inner nut member 118 undergo relative rotation (e.g. the sleeve/collar rotating around the inner nut member), allowing the sleeve/collar to be removed and the segments of the inner nut member can move radially so that the segmented nut is completely released. Alternatively, for fastening/tightening the segmented nut 114, the second engagement portion 124 is engaged with the inner nut member 118 and the third engagement portion is engaged with the reaction portion 112 of the threaded male member110. The tool can then rotate the inner nut member 118 (and therefore the segmented nut type fastener 114) about the threaded male member and the segmented nut the threadingly advances along the threaded male member. It will be appreciated that the second portion and the third portion can work in concert in the reverse direction of rotation to threadingly reverse the segmented nut back along the threaded male member for removal of the assembled segmented nut from the threaded male member.

The first portion 122 of the tool 120 includes first drive engagement means 122A to receive drive from a drive means. The second portion 124 includes second drive engagement means 124A to receive drive from a drive means. The third portion 26 includes third drive engagement means 26A to receive drive from a drive means. The third portion 126 can include an opening 130 to receive therein a fourth portion 128 for engagement with an end of the threaded male member110. See also FIG. 19C. It will be appreciated that such drive engagement can include any one or more of rotational drive, longitudinal drive or drive that maintains/holds position of the respective first, second or third portion while motion drive is imparted to at least one other of the first, second or third portions. Such ‘hold’ drive can be provided, for example, during counter torque situations where one of the first, second or third portions is held during action to rotate one other of the first, second or third portions.

FIG. 19B shows a plan view of the tool 120 embodiment of the present invention shown in FIG. 19A. FIG. 19C shows a partial sectional perspective view of a tool for use in an embodiment of the present invention. FIG. 19D shows an exploded perspective view of a tool for use in an embodiment of the present invention. FIGS. 19E and 19F show respective rotational positions of an inner nut engaging portion of an embodiment of the present invention. FIG. 19E shows the inner nut engagement portion in engagement with the inner nut member prior to release of the nut. FIG. 19F shows the nut in a release orientation.

FIG. 19C shows a tool 120 of an embodiment of the present invention. The tool has a first portion 122 providing a housing 122.1 with a drive engagement means 122A to engage with a drive means. A second portion 124 is provided within the first portion 122. An annular sleeve 125 is between the inner face of the first portion and an outer face of the second portion 124. The annular sleeve 125 accommodates relative rotational movement of the first portion and second potion, reducing internal friction in the device.

The annular sleeve and/or the second portion may be retained within the first portion by at least one retainer, such as an insert configured to engage with the sleeve/collar of the nut (female fastener) as part of the first portion. The insert may be or include a friction/interference fit in the first portion, or may be retained by at least one releasable retainer 119, such as a circlip, spring clip, grub screw, or other suitable releasable retainer.

FIG. 19D shows an exploded view of the tool 120 with first portion 120 providing the housing 122.1, and the second portion 124 with annular sleeve 125 to be provided between an inner face of the first portion and an outer face of the second portion, and the retainer 123 which provides part of the first portion i.e. for engagement with the sleeve/collar of the nut (female fastener).

FIGS. 19E and 19F show assembled (FIG. 19E) and released (FIG. 19F) segments 118a, 118b, 118c of an inner nut member, with the second portion engaging the segments in FIG. 19E, and the segments released to move radially outward in FIG. 19F.

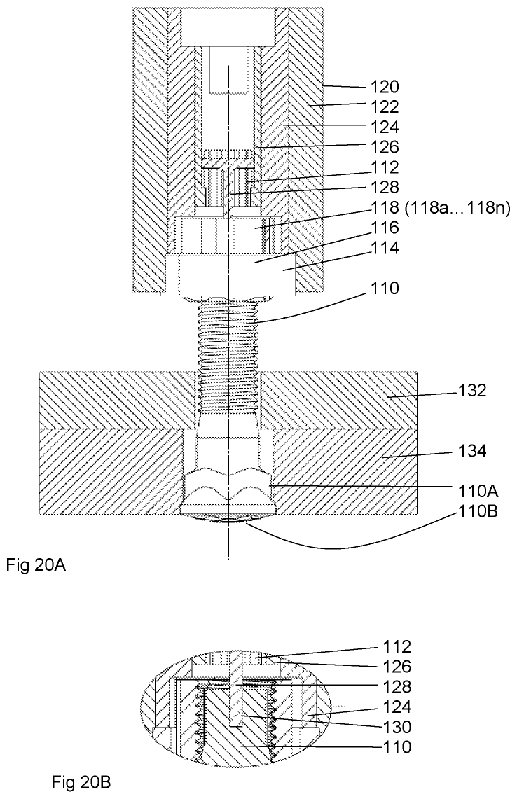

FIG. 20A shows a sectional view through a tool 120 according to an embodiment of the present invention. The tool 20 includes a first portion 22 to engage with the sleeve/collar 116 of the segmented nut 114, a second portion 124 to engage with at least one of the segments 118a and 118n of the inner nut member 118, and a third portion 126 to engage with the reaction portion 112 of the threaded male member 110.

The threaded male member110 is provided as a bolt 110A having a head 110B. The segmented nut 114 is shown initially threading (winding-on) to the free end of the bolt opposite to the head end of the bolt. During initial threading onto the thread of the threaded male member 110, the second portion 124 is engaged with the inner nut member 18 of the segmented nut 114. The first portion 122 may or may not be engaged with the sleeve 16 of the segmented nut at this stage. When eventually tightened, the segmented nut can fasten one or more work pieces, such as clamping work pieces 132, 134 between the segmented nut and the head 110B of the bolt 110A. If the first portion 122 is engaged with the sleeve/collar 116, it is envisaged that the first portion 122 rotates in concert with the second portion 124 to retain positional relationship between the sleeve/collar 116 and the inner nut member 118 to maintain assembly of the segmented nut 114 for winding-on and eventual tightening.

However, whilst the segmented nut 114 commences threading onto the thread of the threaded male member 110, the third portion 126 may not yet be engaged with the reaction portion 112. Consequently, the threaded male member10 may be biased to rotate by frictional grip with the segmented nut 114 under influence of the second portion 124 (and possibly the first portion 122 if engaged with the sleeve/collar 116).

A fourth portion 128 may be provided to engage with an end of the threaded male member 110. The fourth portion can be received into an opening 130, such as a recess, slot, square, hexagonal or star drive opening, or other shape. In addition, or alternatively, the threaded male member110 may be engaged externally thereof (such as at the reaction portion) by the fourth portion, or by a fifth portion in addition to the fourth portion. When the reaction portion is sufficiently exposed from the inner nut member 118 of the segmented nut 114, the third portion 126 may engage with the reaction portion 112, and the fourth portion 128 need not be needed or can remain engaged with the threaded male member 110. The fourth portion may be or include a driver bit, a blade (such as a screwdriver type blade), a square or hexagonal or star drive, or a clamp to engage the reaction portion/end of the threaded male member externally, or a combination of two or more thereof. FIG. 20B shows a portion of a cross section providing detail of an embodiment wherein the fourth portion 128 engages into a slot 130 in the end of the threaded male member 110.

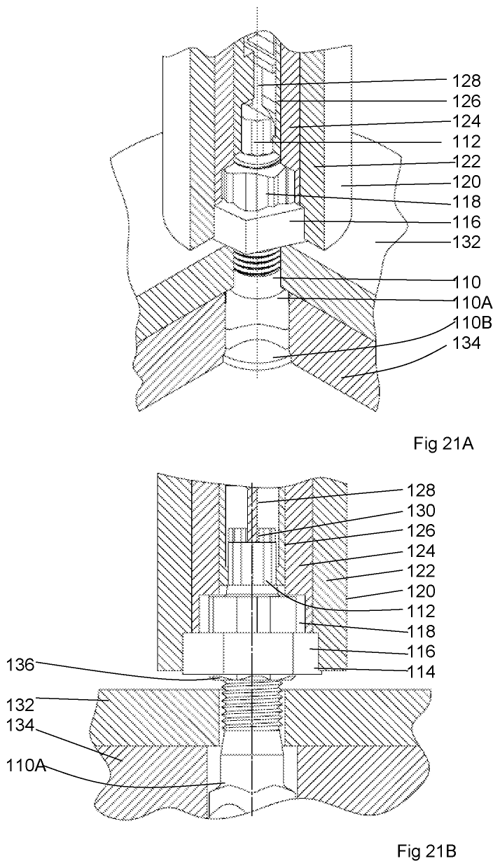

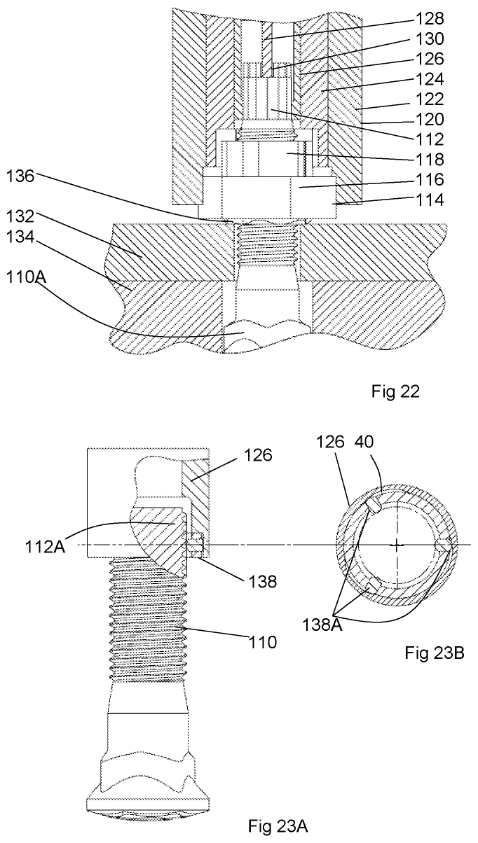

FIGS. 21A and 21B show the segmented nut 114 further wound down/along the thread of the threaded male member 110 than shown in FIG. 20A. Reference numerals are consistent with the features shown in FIG. 20A. Retainers 136 of the segments of the inner nut member extend under the sleeve/collar 116 to axially (longitudinally) retain the sleeve/collar to the inner nut member (and therefore assembly of the segmented nut) until the sleeve/collar is rotated relative to the segments for releasing the inner nut member segments. Likewise, FIG. 22 shows the segmented nut 114 close to engagement with/tightening to the work piece 132, 134.

FIG. 23A shows by way of an exemplary embodiment grip means 138. In this version of grip means, the grip means include multiple jaws 138A that work in concert to engage with an exterior surface of the threaded male member, such as a threaded end 112A thereof. The jaws 138A may be driven radially inward by engagement with a cam surface 140 as the third portion rotates relative to the threaded male member until sufficient purchase is gained by the grip means on the threaded male member and the third portion provides a reaction force (counter torque) to rotation of the second portion engaging with the inner nut member of the segmented nut for tightening the segmented nut. Other variants/alternative to the grip means are envisaged to fall within the scope of the present invention. The grip means may intentionally damage the thread of the threaded male member through such engagement. Such damage can be beneficial in preventing the segmented nut from completely unwinding (such as through vibration) from the threaded male member.

At least one alternative form of the present invention provides for close working to a physical feature adjacent to a nut/threaded male member to which a tool of the present invention is to be used.

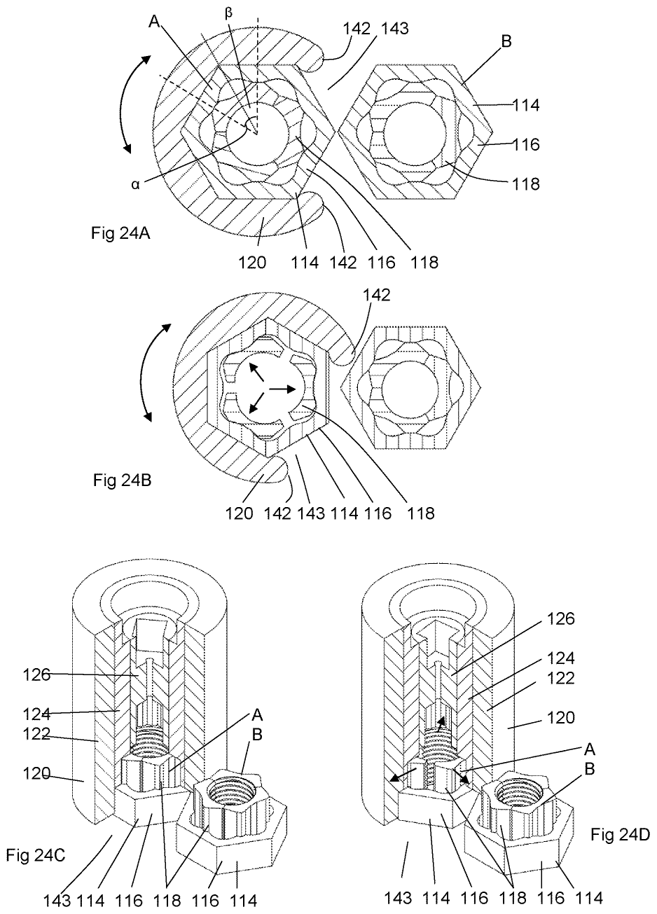

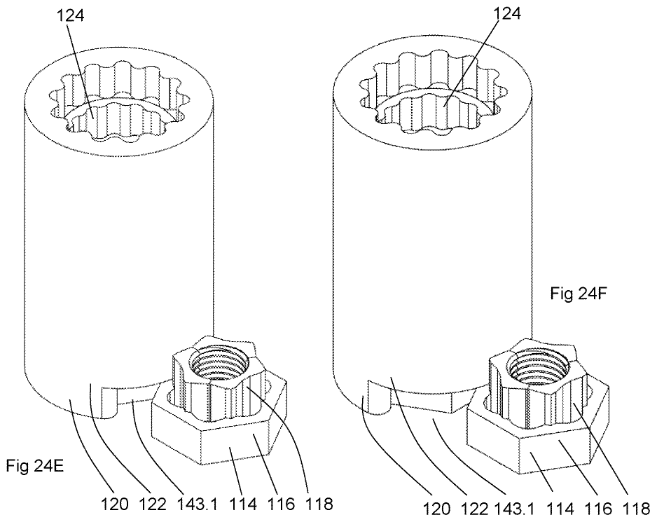

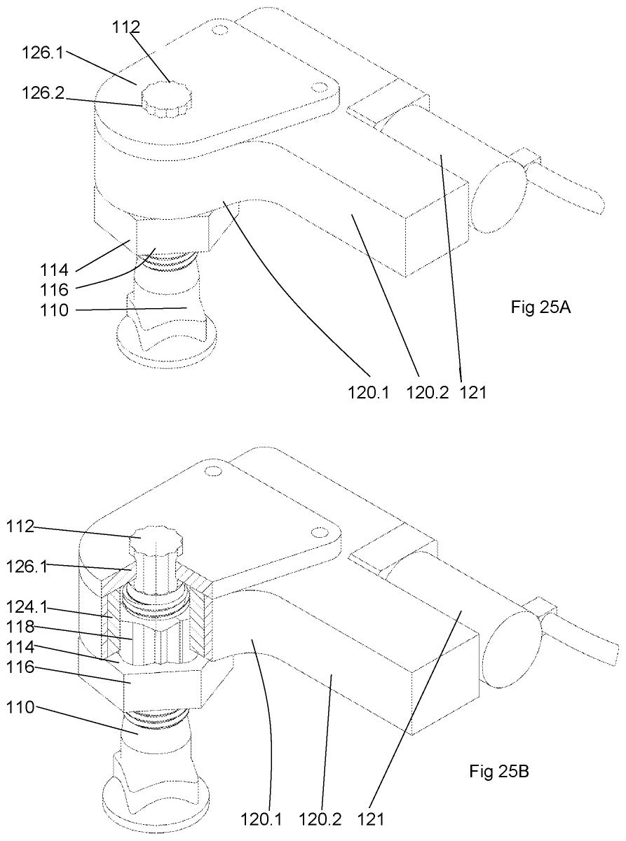

As shown in FIGS. 24A to 24D by way of example through a non-limiting embodiment, the first portion 122 of a tool 120 can include an opening or recess 43.

FIGS. 24A and 24C show the first fastener ‘A’ to be worked on by the tool (in this example, first fastener ‘A’ is to be released). However, second fastener ‘B’ is closely adjacent to the first fastener ‘A’. Ordinarily, the tool (or any socket to act on the collar) with a complete ‘skirt’ would not fit fully onto the sleeve/collar 116 of the first fastener ‘A’ because the second fastener ‘B’ is too close. Having a complete/full thickness first portion risks interference between the tool and the adjacent fastener, possibly preventing full engagement of the tool with the first fastener to be worked on, and thereby damage to or failure to release the first fastener. The recess or opening 143 can be provided by a step in the outer periphery of the first portion or may be an opening such that the sleeve 116 of the segmented nut 114 is partially exposed (i.e. exposed at the opening). The opening can include terminating ends 142.

FIGS. 24B and 24D show the sleeve/collar 116 rotated relative to the inner nut member 118 and the segments are able to move radially outward for release of the segmented nut. The opening/recess 143 of the first portion advantageously enables the tool to engage with the sleeve/collar of the first fastener and thereby release of the first fastener.

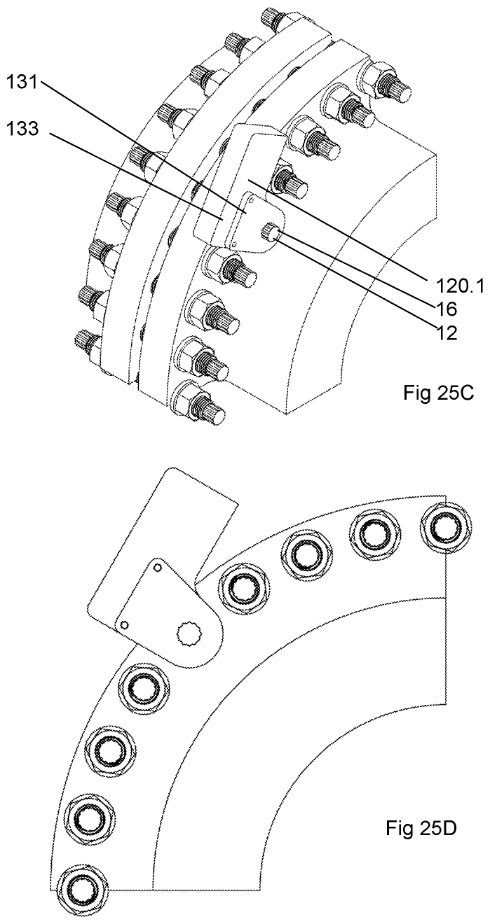

FIGS. 25A to 25B show an embodiment of a powered drive means 121 (such as hydraulic, pneumatic or electric). A tool 120.1 includes a housing 120.2 for a drive mechanism. The tool 120.1 includes a third portion 126.1 to engage with a reaction portion 112 of the threaded male member1110 (such as a bolt as shown).

A second portion 124.1 is provided within the housing 1120.2 of the tool 120.1 to engage with the inner nut member of the segmented nut 14. The second portion powered by the drive means 121 rotates the segmented nut and the torque is reacted through the reaction portion of the threaded male member.

One or more embodiments of the present invention can include selective engagement between the first and second portions and the second and third portions. Preferably, when the first and second portions are operatively engaged together, the third portion is disengaged from the second portion. Likewise, when the second and third portions are operatively engaged, the first portion is disengaged from the second portion.

FIGS. 25C and 25D show an application of side entry tool 120.1, such as shown in FIGS. 25A and 25B, providing a powered tool (e.g. hydraulic lines not shown). The reaction portion 16 of the male threaded male member 12 is retained within a top plate 131 which is rigidly attached to the tool housing 133. An inner socket (not shown) attaches to the nut under the tool.

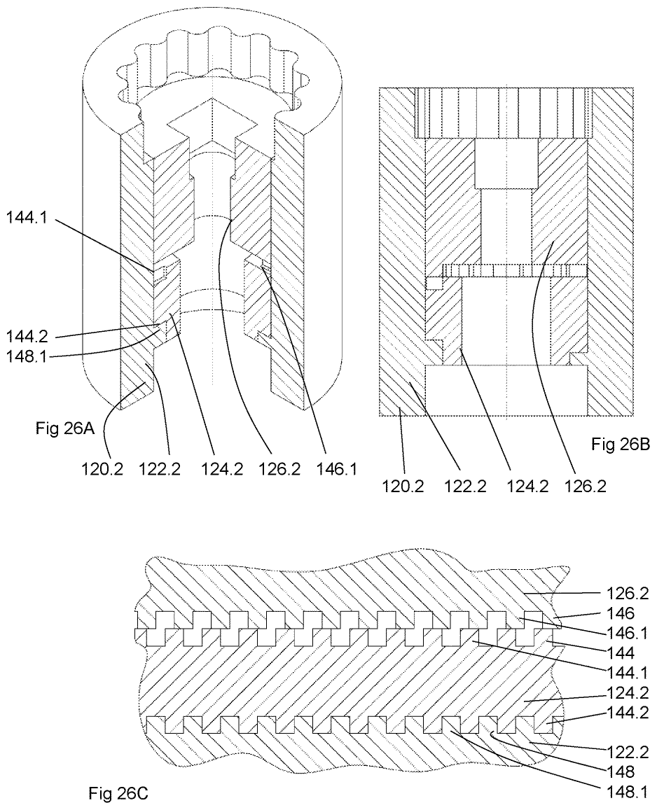

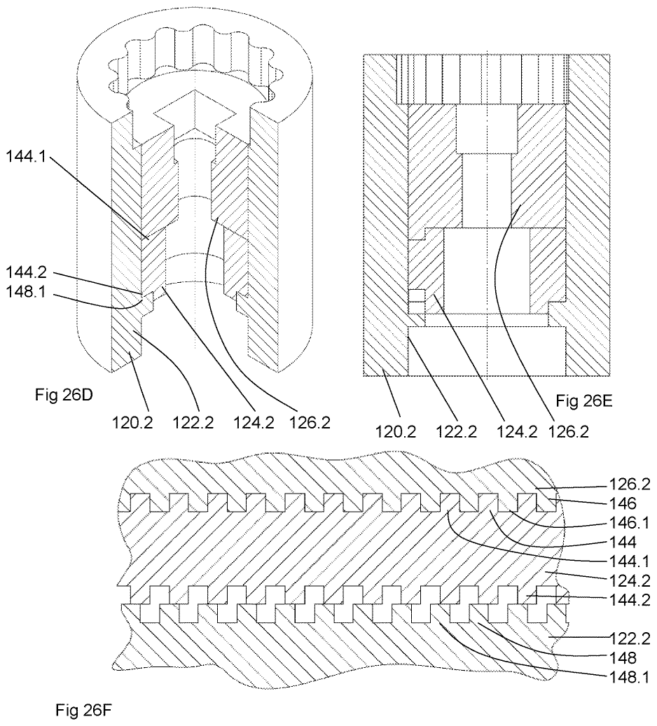

As shown by way of example in FIGS. 26A to 26F, the tool 120.2 can include a toothed engagement arrangement 144 (144.1, 144.2) selectively engaging the second portion 124.2 with the first portion 122.2 or the third portion 126.2. The engagement arrangement can be powered (such as by electrical, pneumatic or hydraulic drive) or can be manually operated. Selection can be by moving one or more of the first, second and third portions relative to at least one other of the first, second and third portions, such as by relative sliding and/or twisting motion thereof.

In the non-limiting embodiment shown in FIGS. 26A to 26F the engagement arrangement includes teeth (square teeth are shown but other shapes and forms are considered to fall within the scope of the present invention).

FIGS. 26A to 26C show selective engagement of the first portion 122.2 and second portion 124.2, such that the first and second portions work as one and allow the application/fastening of the segmented nut along threaded male member with reaction torque provided by the third portion engaged with the reaction portion of the threaded male member.

As shown in FIGS. 26D to 26F, the engagement arrangement permits engagement of the second portion with the third portion, and the first portion is released from engagement with the second portion, such that the first portion can rotate the sleeve/collar of the segmented nut relative to the inner nut member and threaded male member to release the segmented nut.

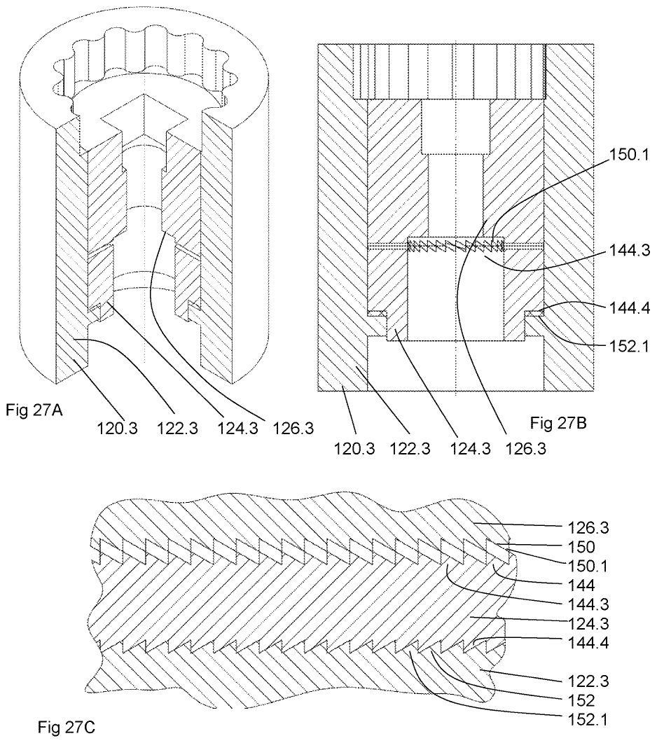

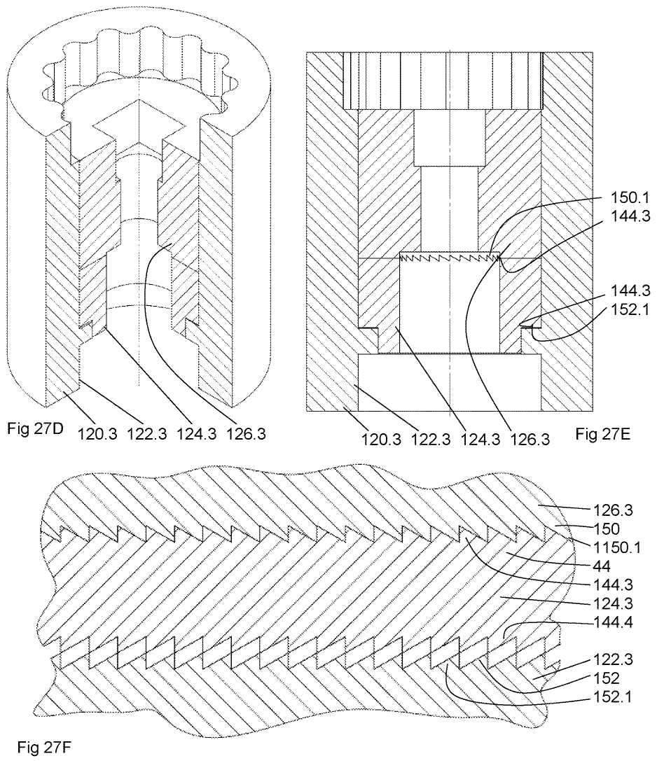

FIGS. 27A to 27F show and alternative engagement arrangement in the form of a ratchet type arrangement 144 with angled teeth 150.1 and 144.3 selectively engaging g or angled teeth 144.4 and 152.1 selectively engaging.

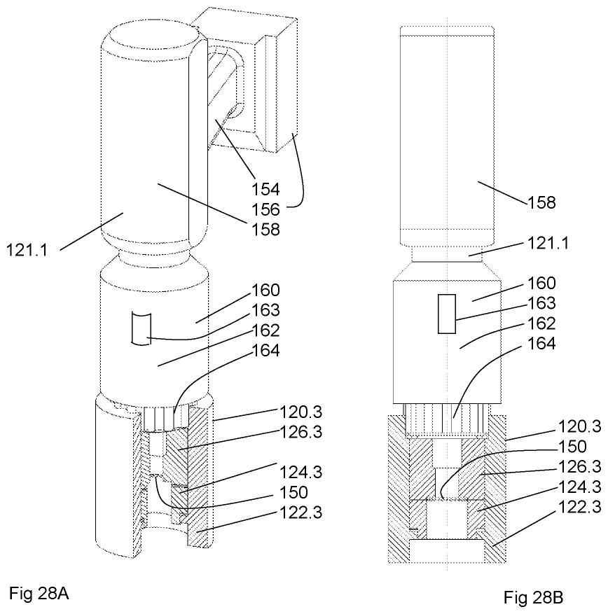

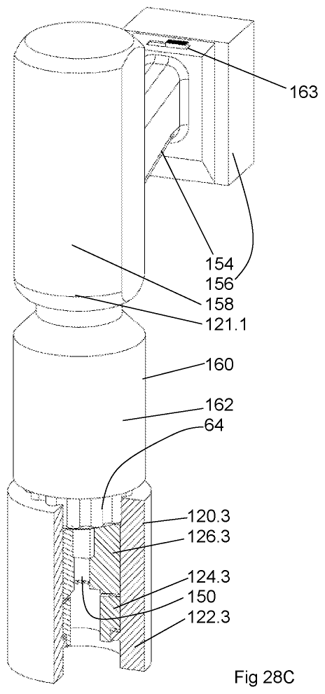

A tool arrangement according to further embodiments of the present invention is shown in FIGS. 28A, 28B and 28C. The tool arrangement can include a powered drive means 121.1 (such as hydraulic, pneumatic or electric). The powered drive means includes a handle 154, a battery pack 156 (which may be replaceable/rechargeable), a motor housing 158 and a drive mechanism housing 60 (e.g. a gearbox or torque multiplier). The drive mechanism 160 can house gearing 162 or a distinct gearbox may be provided), such as reduction gearing, gearing selection and torque conversion/multiplication means. A tool engager 164 engages with the tool, such as tool 120.3 by way of exemplary embodiment. It will be appreciated that the powered drive means may be attached to any of the tools 120 of embodiments of the present invention). The tool 120 (e.g. 120.3) may be irremovably attachable to the powered drive means or permanently attached. Gear ratio or torque multiplier ratio from input to output can be selectable, such as by use of the gearing, gearbox and/or torque multiplier. Selection may be mechanically, electrically or electro-mechanically controlled.

A selection control 163 may be provided which selects between available ratios for higher torque lower speed applications and lower torque higher speed applications. During ‘winding on’, the female fastener may be ‘run’ relatively easily around and along the thread of the threaded male member, and lower torque higher speed rotation may be employed. For fastening, or release of the female fastener, or as torque increases and load builds up in the tool, the tool may be switched to higher torque lower speed operation, such as by using selector switch 163.

As shown in FIGS. 28A, 28B compared to FIG. 28C, the gear ratio/torque selection and/or speed may be selected by a selector switch provided on a base/handle of the power drive means 121.1 or may be provided on the motor housing 158 or drive mechanism 60 housing.

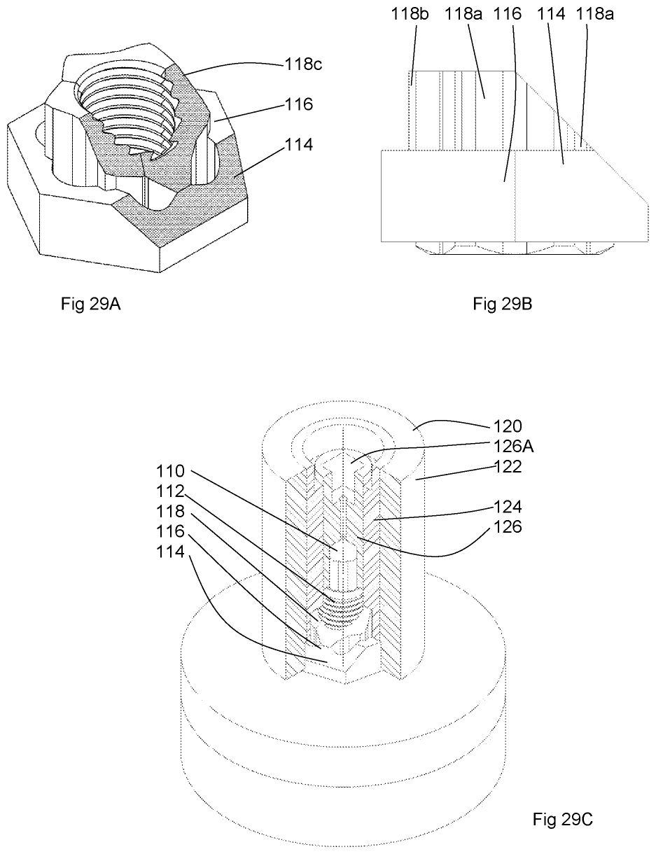

FIGS. 29A and 29B show respective perspective and side views of a worn segmented nut (female fastener) 110 by way of example of wear and/or damage that can occur through use. In particular, part of the exposed ends of bolts and associated fixing nuts can be abraded away or impacted during use due to their location, such as part of a fixing system for ground engaging tools on earth moving buckets and dozer blades.

FIG. 29C shows a partial sectional view of an embodiment of the present invention able to fit onto, engage with and release the worn/abraded female fastener (e.g. segmented nut) despite the severe damage/wear to that fastener. The asymmetric nature of the wear will cause uneven side thrusts on the concentric sockets, 124 & 126. Furthermore, axial “camming off” will occur on socket 124 which will induce a thrust force axially back towards the tool (not shown).

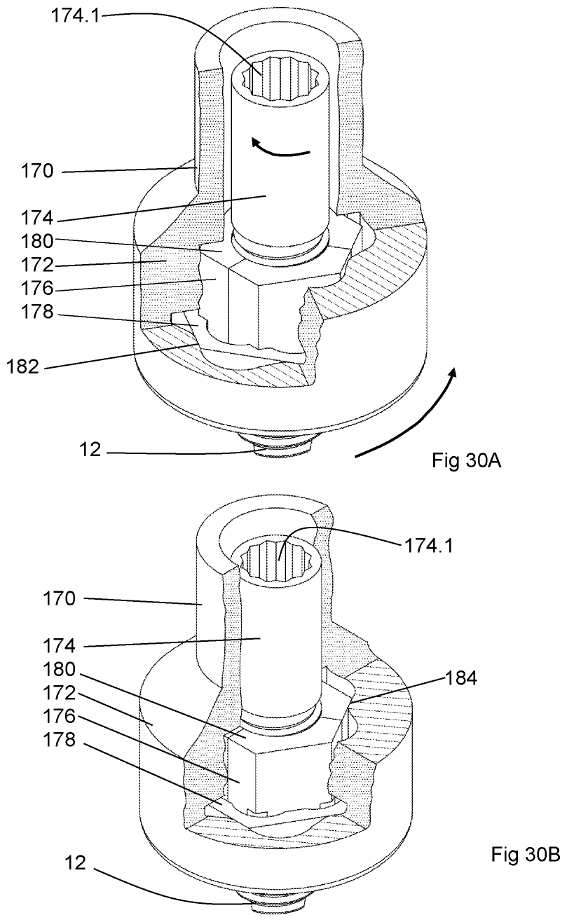

FIGS. 30A and 30B show a tool 170 including an outer socket 172 to engage with an outer sleeve 178 of a nut 176. An inner socket 174 of the tool 170 engages with a reaction portion of a threaded male member 12. The sockets are configured to release the outer-sleeve 178 of a nut with the outer-socket 172 and react the torque on a reaction portion of the threaded male member (such as a bolt) 12 via the inner socket 174.

According to at least one arrangement, the outer-socket 172 can also include an internal structural configuration that engages with the outer hexagonal profile of the inner segments 180 of the nut once the outer-sleeve 178 is released (e.g. after approx. 15 degrees rotation). FIG. 30B shows the sleeve has rotated 15 degrees relative to inner segments (see fig to left) and now the socket profile acts on the inner segments. When the outer-socket 172 is turned in the nut release/unwinding direction and the action of the socket on the inner segments 180 helps to release them from engagement with the thread of the shaft 12. The inner socket 174 of the tool 170 can include an engagement part 174.1 for receiving a driver (not shown) to apply or react torque through the inner socket.

In FIG. 30A, at 182 is shown the inner profile of the outer socket not producing a torque on the segments when in this orientation. In FIG. 30B, the sleeve has rotated 15 degrees relative to inner segments (see FIG. 30A) such that the inner profile of the outer socket acts on the inner segments of the nut (see 184). A condition could exist wherein torque applied to the outer-sleeve 178 loosens the entire nut 176 without releasing the sleeve 178. This would then result in the nut 176 unwinding as a whole. If, however, the nut 176 became seized during the process, then the torque applied to the outer sleeve could rise until a release event occurred.

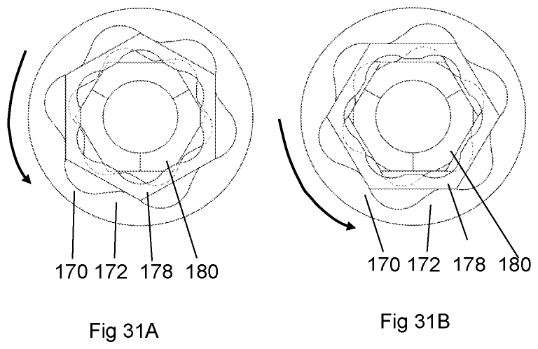

FIGS. 31A and 31B show the steps of releasing the nut using the tool of FIGS. 30A and 30B. As shown in FIG. 31A, the inner profile of the outer socket is engaging with the sleeve of the segmented nut. Clearance regions within the outer socket result in no torque being applied to the inner segments whilst the segmented nut is in an assembled state. As shown in FIG. 31B, with the outer socket and sleeve rotated relative to the inner nut/segments, the sleeve is in a released position relative to the inner nut and the outer socket is engaging with segments at a number of points.

It is to be understood that, if any prior art is referred to herein, such reference does not constitute an admission that the prior art forms a part of the common general knowledge in the art, in Australia or any other country. In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Embodiments include a threaded male member for a fastening arrangement, the threaded male member including at least one reaction portion at or towards at least one respective end of the threaded male member for use in reacting applied torque during tightening or releasing an associated nut of the fastening arrangement.

Embodiments include at least one reaction portion as a permanent feature of the threaded male member and remains part of the threaded male member after said tightening to a target torque. Embodiments include the threaded male member having at least one thread of a same handedness at least at each end of the threaded male member. Embodiments include the threaded male member formed from all-thread. Embodiments include the threaded male member including a said reaction portion provided at or towards each of opposed first and second said ends of the threaded male member.

Embodiments include the at least one reaction portion including a primary reaction portion. Embodiments include the primary reaction portion including at least one spline and/or at least one groove, channel, flute or recess in a portion of the thread of the threaded male member. The at least one of said spline, at least one groove, channel, flute or recess in a portion of the thread of the threaded male member can be provided on an external surface at or towards one end or both opposed ends of the threaded male member. Embodiments include the at least one reaction portion including at least two independently accessible said reaction portions at a same end of the threaded male member.

Embodiments include the at least two reaction portions including the primary reaction portion and a secondary reaction portion. Embodiments include the secondary reaction portion including at least one of an internal cavity, a projection, a slot, a secondary spline, a polygonal shaped recess or other engageable structural feature at an end of the threaded male member, or a combination of at least two thereof. Embodiments include the primary reaction portion and the secondary reaction portion being within an outside diameter of a thread of the threaded male member.

Embodiments include the threaded male member is configured to threadingly receive thereon a respective female threaded fastener at each of opposed ends of the threaded male member. Embodiments include the threaded male member including at least one retention portion for retaining an anti-rotation device and/or a rotation indicator means. Said at least one retention portion can include an undercut, groove or channel in a portion of the threaded male member. Said at least one retention portion can be in or on a respective said reaction portion. Said at least one retention portion can provide a shear portion, wherein, during the tightening, a shearing event at the shear portion is indicative of a failure of a said fastening arrangement. Said at least one retention portion can include at least part of a thread of the threaded male member which provides an axial retention means for the respective anti-rotation device and/or the respective rotation indicator means.

Embodiments include the threaded male member being a permanent or semi-permanent fixed stud. Embodiments include said at least one reaction portion adapted or configured to withstand at least a maximum installation and/or removal torque of the associated nut on the threaded male member. Embodiments include the at least one reaction portion adapted or configured to remain functional as said reaction portion(s) after installation of the threaded male member. A failure, such as partial or full shearing off, of the at least one reaction portion during the tightening can be provided to indicate a failure of a said fastening arrangement.

Embodiments include a fastening arrangement including a threaded male member as claimed in any one of the preceding claims, and at least one nut including a first nut, wherein a torque is applied on the first nut and a counter-torque is applied on the reaction portion at one said end of the threaded male member. Embodiments include the at least one nut of the arrangement including a second nut, the first and the second nut for fastening a work-piece therebetween. Embodiments include the at least one nut prevented or restricted from rotation relative to the threaded male member by at least one anti-rotation device, such as at least one locking device and/or thread-lock. Embodiments include the at least one anti-rotation device configured to withstand between 15% and 50% of a maximum tightening torque applied to the fastening arrangement. Embodiments include the at least one anti-rotation means includes a cap and/or a resilient device. Embodiments include the at least one anti-rotation means configured to engage with the respective reaction portion and the respective nut at the same end of the threaded male member. Application of the at least one anti-rotation means can include angular free-play between the reaction portion and the locking device interface, and between the nut and the locking device interface, allowing the at least one anti-rotation means to be installed on the threaded male member and nut irrespective of an angular relationship between the reaction portion and the nut. Embodiments include at least one anti-rotation means including release means enabling release of the respective anti-rotation means after the tightening has been completed. Embodiments include a release means including a radially movable portion including a releasable clamping means for engagement and disengagement between the radially moveable portion and the reaction portion of the threaded male member. Embodiments include at least one anti-rotation means including biasing means to apply a tightening direction biasing torque to a respective said nut. Embodiments include at least one said anti-rotation means applied to a rear nut during or following installation of the fastening arrangement. Embodiments include a threaded male member configured as a permanent or semi-permanent fixed stud arranged to threadingly receive said at least one nut at one end only thereof. The threaded male member can include at least one engagement portion to engage with a body to prevent relative rotation of the threaded male member with respect to the body. Embodiments include at least one engagement portion including at least one key, spline, polygonal portion, or a combination of any two or more thereof. Embodiments include a fixed stud as a wheel stud for mounting a wheel rim to the body being a wheel hub of a vehicle. Embodiments include at least one nut providing at least one segmented nut.

Embodiments include at least one reaction portion adapted or configured to withstand at least a maximum installation and/or removal torque of an associated said nut on the threaded male member. Embodiments include at least one reaction portion remaining functional as said reaction portion(s) after installation of the threaded male member.

Embodiments include a fastener system including a fastener arrangement including a threaded male member having at least one reaction portion, at least one nut for threading engagement with the threaded male member, and a torque application tool for tightening or releasing the at least one nut on the threaded male member. Embodiments include the tool including at least two sockets including a first socket for engagement with the reaction portion and a second socket for engagement with a said nut. Embodiments include a tool including a said socket for engagement with an inner nut of the segmented nut and another said socket for engagement with a sleeve of said segmented nut.

Embodiments of the fastener system can include at least one anti-rotation device to prevent or restrict relative motion of a said nut and the threaded male member. The anti-rotation device can include a locking device and/or thread-lock. The anti-rotation device can include at least one cap or resilient device. Embodiments include a locking device engageable with a rear said nut and the threaded male member when the tool is applying torque to a front said nut and the threaded male member. Embodiments include at least one reaction portion adapted or configured to withstand at least a maximum installation and/or removal torque of an associated nut on the threaded male member. Embodiments include at least one reaction portion adapted or configured to remain functional as said reaction portion(s) after installation of the threaded male member.

Embodiments include an anti-rotation device for restricting or preventing relative rotation of a fastened nut and threaded male member arrangement. The anti-rotation device can be configured to engage, in use, with a reaction portion of the threaded male member and with the nut to prevent or restrict relative rotation of the nut and the reaction portion. Embodiments include the anti-rotation device including a cap which, in use, at least partially covers the nut. Embodiments include an anti-rotation device including resilient biasing means arranged and configured to, in use, engage with the reaction portion and/or with a thread of the threaded male member. Such resilient biasing means can include a spring clip.

Embodiments include a method of fastening or releasing a threaded male member fastening arrangement having a threaded male member and at least one nut, the method including applying a torque to the respective nut and applying a counter-torque to a reaction portion at a first end of the threaded male member. Embodiments include a threaded male member having a nut threaded thereon at a second end of the threaded male member, and the torque and the counter-torque is applied at the first end of the threaded male member. Embodiments include the reaction portion remaining as part of the threaded male member after required application of the torque to tighten the respective nut(s) to a required tightening torque. For release of a tightened said nut, embodiments can include applying a release torque to the nut and a counter-torque to the reaction portion. For release of a tightened said nut, embodiments can include engaging a tool with the reaction portion, with an inner nut of a segmented nut and with an outer collar/sleeve of the segmented nut, and applying a torque to the inner nut and the sleeve/collar or to the reaction portion and the sleeve/collar, or with the reaction portion, inner nut and sleeve/collar, for release of the nut. Embodiments include applying an anti-rotation means to a tightened said nut and reaction portion. Embodiments include applying a cap over the nut to engage with the nut and the reaction portion, or applying a resilient device or clip to the reaction portion and the nut.

Embodiments include a method of preventing or restricting relative rotation of a nut on a threaded male member of a threaded male member fastener arrangement, the method including having an anti-rotation means engaged with the nut and with a torque reaction portion of the threaded male member. Embodiments include an anti-rotation device including a cap or a resilient device applied to engage with the nut and with the reaction portion. Embodiments include an anti-rotation device configured to engage on the reaction portion and engages with at least one face of the respective nut.

Embodiments include a bolt for use in a wear plate arrangement, the bolt including a cylindrical bolt head and a threaded male member with a reaction portion at a distal end thereof, wherein the threaded male member has a head to retain a wear plate of the wear plate arrangement, wherein the head is received within a close fitting counter-bore in the wear plate and, when assembled, is flush with an outer surface of the wear plate and is exposed to flow of material over the wear plate.

Embodiments include a tool arrangement for engagement with a fastener assembly, the fastener assembly having threadingly engageable male and female fasteners, wherein the female fastener includes an internal thread, and the male fastener has a threaded male member and at least one reaction portion; wherein, for at least part of installation of the female fastener on the male fastener, the tool arrangement engages with and provides a torque to the female fastener and the tool arrangement engages with and reacts a counter-torque through the male fastener; and wherein, for release of the female fastener from the male fastener, the tool arrangement engages with and reacts counter-torque through the female fastener.

Embodiments include at least one tool providing: female fastener reaction means to engage with the female fastener of the fastener assembly, and male fastener reaction means to engage with the male fastener of the fastener assembly. Embodiments of a tool arrangement include at least one tool arranged and configured to apply torque to an outer sleeve of a segmented nut of said female fastener and to simultaneously apply a counter torque to at least one said reaction portion on a shaft of the male fastener for releasing the segmented nut. Embodiments include at least one tool providing: first reaction means to release the female fastener of the fastener assembly, and second reaction means to install the female fastener of the fastener assembly. Embodiments include the female fastener including a nut having a sleeve/collar and an inner nut including multiple segments, and wherein the first reaction means has sleeve/collar and inner nut member engagement portions arranged and configured to respectively engage with the sleeve/collar and the inner nut member wherein a torque is applied to at least one of the sleeve/collar or the inner nut member engagement portions to release the nut, and wherein the second reaction means has nut and threaded male member engaging portions arranged and configured to respectively engage with an inner nut member of a segmented nut and the threaded male member onto which the nut is threaded and provide a torque is applied to at least one of the nut or threaded male member engaging portions counter directional torques to the inner nut member and the threaded male member to threadingly advance or reverse the segmented nut along the threaded male member.

Embodiments include a first reaction means configured to provide counter directional torques for rotation of one of the portions relative to another of the portions. Embodiments include a second reaction means configured to apply counter directional torques to the inner nut member and the threaded male member. Embodiments include the first and the second reaction means as separate tools from each other, or the first reaction means and the second reaction means are provided in a single tool. Embodiments include first reaction means and second reaction means being selectively engageable allowing selection of one or the other of the first and second reaction means. Embodiments include the first reaction means and the second reaction means axially aligned with each other.

Embodiments include a tool arrangement including at least three concentric engagement portions to selectively engage with respective portions of the female fastener and part of the male fastener. Embodiments of the at least three concentric engagement portions include at least three concentric sockets. Embodiments include at least three concentric sockets as part of a single tool. Embodiments include at least three concentric sockets selectively driven from at least two drives. Drive from at least one of the drives to the respective socket can be user selectable by a selection means. Embodiments include a first socket drive arranged and configured to drive a first socket, a second socket drive arranged and configured to drive a second socket, and a drive to a third socket is selectable or not engaged to drive said third socket at all or until selected. Embodiments include a second socket drive arranged and configured to drive a second socket, and a third socket drive arranged and configured to drive a third socket, and a first socket drive to a first socket is selectable or not engaged to drive said first socket at all or until selected. Embodiments include a tool arrangement having selection means to select between driving a first socket and a second socket or between the second socket and a third socket.

Embodiments include a segmented nut fastener sleeve/collar engagement portion and an inner nut member engagement portion rotationally orientated with respect to each other to respectively engage with the sleeve/collar and the inner nut member. Embodiments include the sleeve/collar engagement portion and the inner nut member engagement portion are indexed to align with each other, and therefore with the assemble nut to fit onto the assembled nut. Embodiments include the sleeve/collar engagement portion and the inner nut member engagement portion having positive indexing or alignment confirmation. Embodiments include the sleeve/collar engagement portion and the inner nut member engagement portion having a rotation limit with respect to one another such that relative rotation of the sleeve/collar and the inner nut member of the segmented nut is limited by the rotation limit. Embodiments include a rotation limit allowing relative rotation of the sleeve/collar and inner nut member from an assembled orientation to a release orientation and the relative rotation is less than 180°. Embodiments include a sleeve/collar engagement portion and an inner nut member engagement portion rotationally engage to a threshold torque with the respective sleeve/collar and inner nut member prior to relative rotation sleeve/collar and inner nut member to release the nut. Embodiments include of at least one tool include sensing means to sense a reduction in torque to stop rotation when the tool is in a release mode. Embodiments include at least one tool for use in releasing a segmented nut from a threaded male member, the segmented nut including multiple inner segments and an outer sleeve, the at least one said tool including: a first portion configured to engage with the sleeve; a second portion configured to engage with at least one segment of the inner nut member, and a third portion to engage with at least one said reaction portion of the threaded male member; wherein, for releasing the segmented nut, the respective tool has selective engagement of the first portion with the sleeve and the second portion with the at least one segment, for relative rotation of the sleeve and the inner nut member; and for tightening the segmented nut, the respective tool has selective engagement of the second portion with the at least one segment and the third portion with the respective reaction portion of the threaded male member, allowing relative rotation of the segmented nut and the threaded male member. Embodiments include one or more of the first portion, the second portion and the third portion is arranged and configured to move rotationally and/or longitudinally with respect to one to at least one other of the first portion, second portion and third portion relative to a central axis of the respective tool. For release of a segmented nut, embodiments of a tool include relative sliding motion of the first portion with respect to the second portion and/or the second portion relative to the third portion. Embodiments include a selection mechanism to selectively move one or more of the first, second and third portions for selective respective engagement of the respective tool with the fastener and/or the respective reaction portion of the threaded male member. Embodiments include at least one clamp arrangement arranged and configured to clampingly engage with at least one of the female fastener and the threaded male member. Embodiments include at least one clamp arrangement is arranged and configured to clampingly engage a sleeve/collar and/or inner nut member segment(s) of a segmented nut of the female fastener and/or clampingly engage with said reaction portion of the threaded male member of the male fastener. Embodiments include grip means to, in use, grip an end portion of the threaded male member. Grip means can include multiple engagers that together grip the end portion of the threaded male member.

Embodiments include a second reaction means including end engagement means to engage with an end portion of the threaded male member. Embodiments include the second reaction means including biasing means to bias the end engagement means for biased engagement and/or disengagement with the end portion.

Embodiments include a reaction portion of a threaded male member including a primary reaction portion and a secondary reaction portion. A primary reaction portion can include an external portion of the threaded male member. A secondary reaction portion includes an internal portion or an external portion of the threaded male member, or a combination thereof. A secondary reaction portion can include an internal cavity or slot portion for receiving part of the tool and/or the reaction portion includes an external portion, such as a projection or head. Embodiments of a first reaction means can include at least one clearance region that allows the tool to fit over end engage with a nut that is relatively close to another nut in situ or other fixed feature. The at least one clearance region can include an opening and/or a recess.

Embodiments include a thread engager to engage with the thread of the threaded male member, wherein the thread engager is provided as part of, or working in association with, the second reaction means and wherein the thread engager includes at least one thread engagement portion that distorts, deforms or damages the thread of the threaded male member. Embodiments include at least one engagement portion that increases inwardly directed force on the thread as the second reaction means tries to rotate relative to the reaction portion of the threaded male member in response to the torque applied to the inner nut member. Embodiments include selective engagement between the first and second portions and/or between the second and third portions. Embodiments include the first and second portions being operatively engaged together, the third portion is disengaged from the second portion. When the second and third portions are operatively engaged, the first portion can be in a disengaged orientation relative to the second portion. Selective engagement can be provided by a clutch and/or ratchet mechanism.

Embodiments include radial load bearing and/or axial load bearing at least between the first portion and the second portion. Embodiments include at least one tapered roller bearing providing radial and axial thrust reaction between the first portion and the second portion.

Embodiments include the first portion arranged and configured to engage with the sleeve/collar of the female fastener and the second portion is arranged and configured to engage with the inner nut member. Embodiments of the tool can include two concentric portions, an outer concentric portion and an inner concentric portion, wherein the outer of the two concentric portions is configured to engage with a sleeve of a segmented nut and the inner concentric portion is configured to engage with a portion of a threaded male member, wherein the outer concentric portion moves the sleeve to a release position relative to an inner nut of the segmented nut, and the outer concentric portion continues to rotate and engage with the inner nut and thereby rotate the segmented nut relative to the threaded male fastener.

Embodiments include a tool arrangement and at least one female fastener and/or at least one male fastener. The at least one female fastener can at least one segmented nut and/or the at least one male fastener includes at least one threaded male member having a reaction bit capable of transmitting a torque to a threaded portion of the threaded male member. Embodiments of a fastener system provide a tool and fasteners set. Embodiments of a tool arrangement can include at least three concentric engagement portions to selectively engage with respective portions of a female fastener and a male threaded male member. One of the concentric portions can be arranged and configured to engage with the threaded male member, and two of the concentric portions are arranged to engage with the female fastener. One of the two of the concentric portions can be arranged and configured to engage with an engagement portion of a sleeve of a segmented nut, and the other of the two engagement portions is arranged to engage with an engagement portion of an inner nut of the segmented. Embodiments include at least three concentric engagement portions including at least three coaxial sockets. Embodiments include at least three concentric engagement portions are part of a single tool. Embodiments include at least three concentric engagement portions selectively driven from at least two drives. Drive from at least one drive to the respective socket can be user selectable by a selection means.

Embodiments include a first socket drive arranged and configured to drive a first said socket, a second socket drive arranged and configured to drive a second said socket, and a drive to drive a third said socket is selectable or not engaged to drive said third socket at all or until selected. Embodiments include a second socket drive arranged and configured to drive said second socket, and a third socket drive arranged and configured to drive said third socket, and a first socket drive to said first socket is selectable or not engaged to drive said first socket at all or until selected. Embodiments include a tool arrangement having selection means to select between driving the first socket and the second socket or between the second socket and the third socket. Drive to a first and a second socket can be in concert such that the first and second sockets rotate together. Embodiments include an outer concentric portion of the at least three concentric portions configured to engage with a sleeve of a segmented nut, wherein the outer concentric portion moves the sleeve to a release position relative to an inner nut of the segmented nut, and the outer concentric portion continues to rotate and engage with the inner nut and thereby rotate the segmented nut relative to the threaded male member.

Embodiments include a method of tightening a fastening arrangement having a threaded male member and a female fastener with an internal thread to threadingly receive the threaded male member, the method including applying a torque to the female fastener and a counter torque to the threaded male member, sensing a change in a rate of change in torque (ΔT) applied to the fastening arrangement relative to a change in rate of change of angle (ΔA) of rotation of the female fastener or the threaded male member, and determining that tightening of the fastening arrangement is at a required equivalent tension value when the sensed change in the rate of change of torque relative to the rate of change of angle reduces. Embodiments include tightening of the fastening arrangement being determined to be at a required torque value when the sensed change in the rate of change of torque relative to the rate of change of angle reduces by a predetermined amount. The predetermined amount can be a predetermined percentage of a maximum of the ratio of the rate of change of torque relative to the rate of change of angle during the fastening. The predetermined percentage can be between 10% and 90%, preferably between 20% and 80%, more preferably between 30% and 70%, more preferably between 40% and 60%, and preferably around 50% of the maximum torque applied during the fastening.

1. A tool arrangement for engagement with a fastener assembly, the fastener assembly having threadingly inter-engageable male and female fasteners, wherein the female fastener includes an internal thread, and the male fastener has a threaded male member and at least one reaction portion; wherein the tool arrangement includes at least two concentric engagement portions to selectively engage with respective portions of the female fastener and the threaded male member, wherein, in use, the tool arrangement is engaged with and provides a torque to the female fastener, and the tool arrangement is engaged with and reacts a counter-torque through the reaction portion of the male fastener.

2. The tool arrangement of claim 1, wherein the at least two concentric engagement portions include a torque socket arrangement including a first socket for engaging with a said reaction portion of the threaded male member and a second socket for engaging with the female fastener, the first and second sockets being concentric with each other.

3. The tool arrangement of claim 2, wherein the first socket is at least partially within the second socket.

4. The tool arrangement of claim 2, including a third socket concentric with the first and second sockets, the third socket configured for engagement, in use, with a sleeve or collar of the female fastener, the female fastener having an inner nut including multiple segments and an outer said sleeve or collar.

5. The tool arrangement of claim 4, wherein the third socket is an outer socket at least partially containing the first socket and the second socket.

6. The tool arrangement of claim 4, wherein the third socket is an outer concentric socket that, in use, rotates the sleeve or collar to a release position relative to the inner nut and the outer socket is configured to continue to rotate and engage with the inner nut and thereby rotate the inner nut relative to the threaded male member.

7. The tool arrangement of claim 1, including a drive portion configured for engagement, in use, with drive from a power tool, or a manual tool, or the tool arrangement incorporates power drive.

8. The tool arrangement of claim 7, including powered drive from the power tool or the power drive, the tool arrangement including means for detecting reduction in rate of change of torque versus angle of rotation of the female fastener relative to the threaded male member when the fastener assembly transitions from elastic to plastic strain.

9. The tool arrangement of claim 7, wherein the power drive to the respective engagement portion is user selectable by a selection means.

10. The tool arrangement of claim 1, wherein the male fastener includes at least one body or work piece engagement portion configured to engage with a body or work piece to restrain relative rotation of the threaded male member relative to the body or the work piece.

11. The tool arrangement of claim 10, wherein the at least one body or work piece engagement portion includes at least one of a spline, a key or shape, a polygonal portion, or an anti-rotation device, or a combination of any two or more thereof, to engage with the body or the work piece to restrain the male fastener from rotation relative to the body or the work piece and relative to the female fastener.

12. The tool arrangement of claim 1, wherein the male fastener includes a first end and a second end, wherein the reaction portion is provided at least at one of the first or second ends.

13. The tool arrangement of claim 12, including an anti-rotation device at the second end when the tool arrangement applies torque to the female fastener reacted through the reaction portion at the first end of the male fastener.

14. The tool arrangement of claim 1, wherein the at least two concentric engagement portions are configured for sliding motion relative to one another.

15. The tool arrangement of claim 14, including a selection mechanism to selectively move one or more of the at least two concentric engagement portions for selective engagement with the respective female fastener and/or the reaction portion of the threaded male member of the male fastener.

16. A method of applying the torque to a fastening assembly having an internally threaded female fastener and a male fastener with a threaded male member, the method including detecting reduction in rate of change of torque versus angle of rotation of the female fastener relative to the threaded male member when the fastening assembly transitions from elastic to plastic strain.

17. The method of claim 16, including:
applying a torque to the female fastener and a counter torque to the threaded male member,
sensing a change in the rate of change in torque (ΔT) applied to the fastening assembly relative to the change in rate of change of angle (ΔA) of rotation of the female fastener or the threaded male member; and
determining that tightening of the fastening arrangement is at a required equivalent tension value when the sensed change in the rate of change of torque relative to the rate of change of angle reduces.

18. The method of claim 17, including stopping tightening of the fastening assembly when the sensed change in the rate of change of torque relative to the rate of change of angle reduces by a predetermined amount.

19. The method of claim 18, wherein the predetermined amount includes a predetermined percentage of a maximum of a ratio of the rate of change of torque relative to the rate of change of angle during the fastening.

20. The method of claim 19, wherein the predetermined percentage is between 10% and 90%, preferably between 20% and 80%, more preferably between 30% and 70%, more preferably between 40% and 60%, and preferably around 50%, of the maximum torque applied during the fastening.

21. The method of claim 16, including providing an anti-rotation device at one end of the threaded male member preventing or restricting relative rotation when tightening or loosening the female fastener an opposite end of the male fastener.

22. The method of claim 16, including engaging at least one body or work piece engagement portion of the male fastener with a body or work piece that restrains relative rotation of the threaded male member relative to the body or the work piece.

23. The method of claim 22, wherein the at least one body or work piece engagement portion includes at least one of a spline, a key or shape, a polygonal portion, or an anti-rotation device, or a combination of any two or more thereof, being engaged with the body or the work piece to restrain the male fastener from rotation relative to the body or the work piece and relative to the female fastener.
